(19) United States
(12) Patent Application Publication
(10) Pub. No.: US 2022/0227939 A1
(43) Pub. Date: Jul. 21, 2022

(54) SILYL TERMINATED PREPOLYMER AND COMPOSITION COMPRISING THE SAME

(71) Applicants: SOPREMA, STRASBOURG (FR); UNIVERSITE DE HAUTE ALSACE, Mulhouse Cédex (FR)

(72) Inventors: Baptiste CLEMENT, BERMERING (FR); Pascal PICHON, STRASBOURG (FR); Jean-François STUMBE, STRASBOURG (FR); Rémi PERRIN, BOERSCH (FR); Pierre Etienne BINDSCHEDLER, STRASBOURG (FR)

(21) Appl. No.: 17/610,193

(22) PCT Filed: May 20, 2020
(86) PCT No.: PCT/EP2020/064163

§ 371 Date: Nov. 10, 2021

(30) Foreign Application Priority Data
May 24, 2019 (EP) 19305660.3

(51) Int. Cl. C08G 73/06; C09J 179/04; C09D 179/04; C08K 3/26; C08K 5/12

(52) U.S. Cl. CPC C08G 73/0633; C09J 179/04; C08K 2003/265; C08K 3/26; C08K 5/12; C09D 179/04

(57) ABSTRACT

The invention relates to a silyl terminated prepolymer and to a curable composition containing this prepolymer. These compositions are used to make sealants, coatings or adhesives useful in the field of construction, public works and civil engineering.

### TECHNICAL FIELD

The invention relates to a silyl terminated prepolymer and to a curable composition containing said prepolymer. These compositions are used to manufacture sealants, coatings or adhesives useful in the field of construction, public works and civil engineering.

### BACKGROUND OF THE INVENTION

In public works or construction works, it is necessary to protect structures, generally made of concrete, against any infiltration of water. To do this, sealants or coatings are applied on the structures.

The use of liquid compositions is preferred over prefabricated membranes as they are easier to apply and lead to flexible and continuous membranes that adhere to the structure.

Sealants or coatings can be obtained from acrylic dispersions in aqueous solution which harden on loss of water. However, these products have the drawback of hardening at the surface after application, forming a very thin coating which makes the evaporation of water difficult, thus giving rise to the formation of blisters. These products cure slowly, especially in cold weather, they are very sensitive to rain before they have totally cured, and they form blisters in summer. What is more, these products show poor resistance to prolonged immersion in water, and are therefore unsuitable for waterproofing horizontal flat surfaces. Finally, their mechanical strength is insufficient for use on traffic-bearing surfaces.

Sealants or coatings obtained with polyurethane resins are also known, for example two-component compositions or one-component compositions containing significant amounts of solvents and/or plasticizers. Two-component compositions are less practical to apply than one-component compositions as they require special mixing equipment and careful metering of the two components.

Further, the use of solvents generates compositions having the following drawbacks:
an unpleasant odor due to the volatile organic compounds,
a toxicity that results in specific labeling and specific operating conditions,
problems with regard to environmental regulations.

Additionally, the use of inert exogenous plasticizers generates compositions having the following drawbacks:
weakening of the mechanical strength,
weakening of the adhesion,
reduced aging over time,
increased water absorption.

Also, polyurethane resins contain residual diisocyanates which are considered as harmful to health and to the environment since they may release free diisocyanate monomers.

Two-part silicone sealants or coatings can be produced by an addition cure method involving a platinum catalyst. One method can include, for example, a silicone hydride and a vinyl-functionalized resin, which react in the presence of a platinum catalyst by hydrosilylation to form an ethyl group bridge between the two components with no additional byproducts. Such platinum catalyzed hydrosilylation systems, while potentially fast curing, can be easily inhibited by tin, sulfur, or other functionalities present in the system (e.g., amines, etc.).

Further, silyl-modified polymers, such as silyl-modified polyethers (MS polymers) and silyl-modified polyurethanes (SPUR polymers) are commonly utilized in adhesives and sealants. In particular, such compositions have been used in one-component sealants that are moisture cured. Like the two-part sealants described above, hydrosilylation is often employed to form the silyl-modified polymers used in the moisture-curable sealants.

There is still a need for prepolymers and liquid one-component curable compositions to provide elastomeric sealants, coatings or adhesives that exhibit one or more of the following properties:
0-1% by weight of free isocyanate monomers
0-5% by weight of solvent
fast curing at room temperature (20-25° C.)
complying with the requirements of a liquid waterproofing system in terms of elasticity, hydrophobicity, hydrolysis resistance, mechanical properties (tensile strength and elongation) and durability.

### SUMMARY OF THE INVENTION

A first object of the present invention is a prepolymer represented by formula (1):

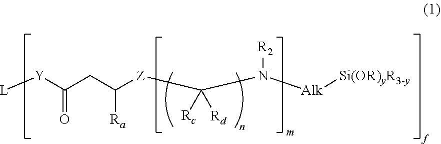

wherein L, Y, Z, R₂, Rₐ, R_{c}, R_{d}, Alk, R, f, m, n and y are as defined herein.

The invention also aims at providing a method for preparing a prepolymer, wherein said method comprises reacting an electrophile of formula (3) or (Prep) with a silane of formula (4):

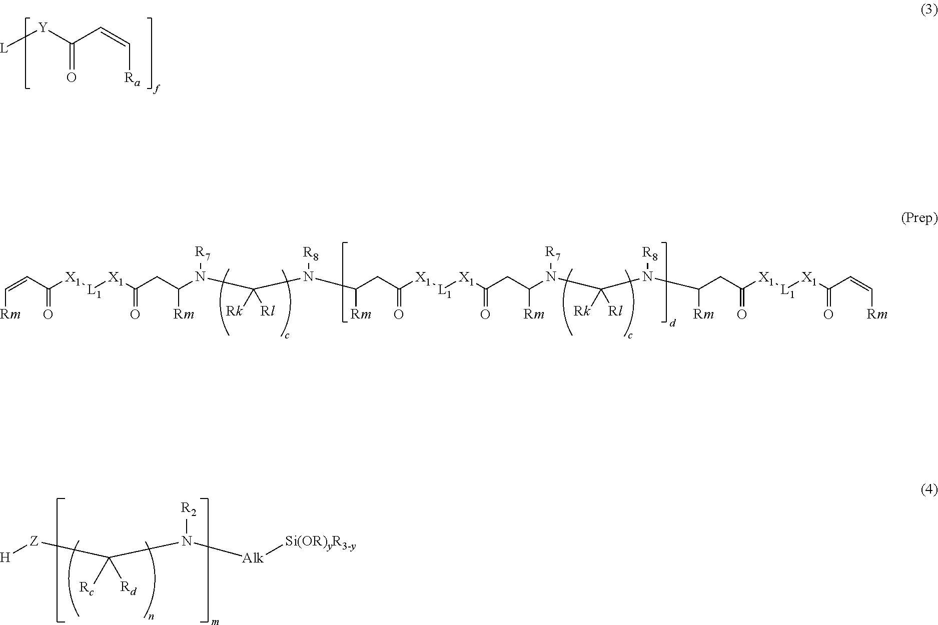

wherein L, L₁, Y, Z, X₁, R, Rₐ, R_{c}, R_{d}, Rₖ, Rₗ, Rₘ, R₂, R₇, R₈, Alk, c, d, f, m, n and y are as defined herein;

when Z is S or NR₁ and R₁ is not H, the molar ratio between the hydrogens on the amine or thiol reactive groups of the silane and the α,β-unsaturated carbonyl groups of the electrophile is from 0.8 to 1.2, preferably 0.9 to 1.1, more preferably 0.95 to 1.05;

when Z is NH, the molar ratio between the hydrogens on the amine reactive groups of the silane and the α,β-unsaturated carbonyl groups of the electrophile is from 1.8 to 2.2, preferably 1.9 to 2.1, more preferably 1.95 to 2.05.

Another object of the present invention is a composition comprising a prepolymer according to the invention and mixtures thereof; and an additive selected from a plasticizer, a filler, an adhesion promoter, a pigment or dye, a UV-absorber, a UV-stabilizer, an antioxidant, a moisture scavenger, a fungicide, a biocide, a fire-retardant, a rheology modifier, an oxygen barrier and mixtures thereof.

Yet another object of the present invention is a sealant, coating or adhesive obtained by curing the composition according to the invention, preferably at a temperature of −10 to 50° C., in particular −5 to 45° C., more particularly 0 to 40° C., during a time of 1 to 72 h, in particular 2 to 30 h, more particularly 3 to 24 h.

A final object of the present invention is the use of the composition according to the invention for waterproofing exterior or interior traffic-bearing horizontal surfaces, for making flashings, or for renovating roofs.

### Definitions

The term “plurivalent radical” means any group having one or more, for example two (divalent), three (trivalent), four (tetravalent), five (pentavalent) or six (hexavalent), single bonds as points of attachment to other groups.

The term “hydrocarbyl radical” means a radical containing 1 to 500 carbon atoms. The hydrocarbyl radical may be linear or branched, cyclic or acyclic, saturated or unsaturated, aliphatic or aromatic. The hydrocarbyl radical may be interrupted by one or more functional groups selected from ether (—O—), thioether (—S—), disulfide (—S—S—), ester (—C(O)—O—), amide (—C(O)—NH—), carbamate (—NH—C(O)—O—), urea (—NH—C(O)—NH—), dimethylsiloxane (—Si(Me)₂—O—) and mixtures thereof. One or more of the carbon atoms of the hydrocarbyl radical may be replaced by a nitrogen atom or an isocyanurate group having the following formula:

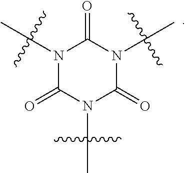 [SMILES: *n1c(=O)n(*)c(=O)n(*)c1=O]

The hydrocarbyl radical may be unsubstituted or substituted by one or more substituents as defined below.

The term “alkyl” means a hydrocarbyl containing 1 to 20 carbon atoms. The alkyl groups may be linear or branched, acyclic or cyclic. Examples include methyl, ethyl, n-propyl, isopropyl, cyclopropyl, n-butyl, isobutyl, sec-butyl, tert-butyl, n-pentyl, cyclopentyl, 2-methylbutyl, 2,2-dimethylpropyl, n-hexyl, cyclohexyl, 2-methylpentyl, 2,2-dimethylbutyl, n-heptyl, 2-methylhexyl, and the like. The term “C1-C20 alkyl” means an alkyl containing 1 to 20 carbon atoms.

When the suffix “ene” or “diyl” is used in conjunction with an alkyl or alkenyl group, this means that the group contains two single bonds as points of attachment to other groups (divalent radical).

The term “aryl” means a polyunsaturated aromatic hydrocarbyl containing one ring (i.e. phenyl), several fused rings (for example naphthyl) or several rings linked via a covalent bond (for example biphenyl), which typically contain 6 to 20, and preferentially 6 to 12, carbon atoms, and wherein at least one ring is aromatic.

The aromatic ring may optionally comprise one to two additional fused rings (i.e. cycloalkyl, heterocycloalkyl or heteroaryl). The term “aryl” also encompasses partially hydrogenated derivatives of the carbocyclic system is described above. Examples include phenyl, naphtyl, biphenyl, phenanthrenyl, naphthacenyl, and the like. The term “C6-C12 aryl” means an aryl containing 6 to 12 carbon atoms.

The term “alkylaryl” means a linear or branched alkyl substituent containing a carbon atom attached to an aryl ring. Examples include benzyl, naphthylmethyl, phenethyl, and the like. The term “C6-C12 alkylaryl” means an alkylaryl containing 6 to 12 carbon atoms.

The term “X forms a cycle with Y” means that X and Y, together with the atoms to which they are attached, form an optionally substituted cycle. Example of cycles are a succinimide, a piperidine, or a piperazine, respectively represented by the following formulae

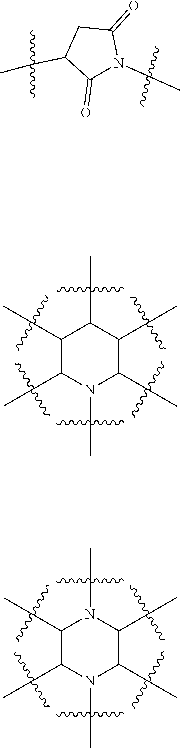 [SMILES: *C1CC(=O)N(*)C1=O ; *C1C(*)C(*)N(*)C(*)C1* ; *C1C(*)N(*)C(*)C(*)N1*]

The following groups: hydrocarbyl radical, alkyl, aryl, alkylaryl and cycle may be unsubstituted or substituted with one or more standard substituents selected from: halogen, alkyl, aryl, hydroxy (—OH), alkoxy (—OR), haloalkyl, cyano (—CN), carboxyl (—COOH), oxo (═O), formyl (—CHO), ester (—COOR), imido (═NR), amido (—CONHR), a tertiary amino group (—NR₂), nitro (—NO₂), sulfonyl (—SO₂—R) wherein each R is independently C1-C20 alkyl, C6-12 aryl or C6-C12 alkylaryl group.

The term “halogen” refers to chlorine, bromine, fluorine and iodine.

The term “haloalkyl” means an alkyl substituted by a halogen atom. Examples include fluoro-, chloro-, bromo-, or iodo-methyl, -ethyl, -propyl, -isopropyl, -butyl, -isobutyl, -tert-butyl, and the like.

The term “alkoxy” means a —OR group, where R represents an alkyl, cycloalkyl, aryl or alkylaryl group. Examples include methoxy, ethoxy, propoxy, butoxy, cyclohexyloxy, phenoxy, benzyloxy, and the like.

The term “hydrocarbyl radical derived from an alkane” means a hydrocarbyl radical obtained by removing one or more terminal hydrogens from an alkane. Said radical may further be functionalized as defined above.

The term “hydrocarbyl radical derived from a polyether” means a hydrocarbyl radical interrupted by one or more ether functional groups (—O—). Said radical may further be functionalized as defined above.

The term “hydrocarbyl radical derived from a polyester” means a hydrocarbyl radical interrupted by one or more ester functional groups (—C(O)O—). Said radical may further be functionalized as defined above.

The term “hydrocarbyl radical derived from a polydimethyl siloxane” means a hydrocarbyl radical interrupted by one or more dimethylsiloxane functional groups (—Si(Me)₂—O—). Said radical may further be functionalized as defined above.

The term “hydrocarbyl radical derived from poly(alkyl (meth)acrylate)” means a hydrocarbyl radical substituted by one or more ester functional groups (—COO(C1-C20 alkyl)). Said radical may further be functionalized as defined above.

The term “hydrocarbyl radical derived from a polybutadiene” means a hydrocarbyl radical comprising one or more butenediyl monomeric units. Said radical may further be functionalized as defined above.

The term “hydrocarbyl radical derived from a polysulfide” means a hydrocarbyl radical interrupted by one or more thioether functional groups (—S—). Said radical may further be functionalized as defined above.

The term “hydrocarbyl radical derived from a polyurethane” means a hydrocarbyl radical interrupted by one or more urethane functional groups (—NH—C(O)—O—). Said radical may further be functionalized as defined above.

The term “hydrocarbyl radical derived from an epoxy acrylate” means a hydrocarbyl radical comprising a moiety obtained by reacting an multifunctional epoxy resin and an acrylic acid. Said radical may further be functionalized as defined above.

The term “multifunctional epoxy resin” means a compound or polymer comprising at least two epoxy groups.

The term “multifunctional isocyanate resin” means a compound or polymer comprising at least two isocyanate groups.

The term “multifunctional (meth)acrylate resin” means a compound or polymer comprising at least two (meth)acrylate groups.

The term “multifunctional acrylamide resin” means a compound or polymer comprising at least two acrylamide groups.

The term “multifunctional maleimide resin” means a compound or polymer comprising at least two maleimide groups.

The term “poly(meth)acrylate resin” means a polymer comprising monomeric units derived from acrylic acid, a mono-acrylate, methacrylic acid, a mono-methacrylate, cyanoacrylic acid, a mono-cyanoacrylate, acrylonitrile and mixtures thereof. Said polymer may be an acrylic co-polymer which further comprises monomeric units derived from compounds other than those cited above, such as, for example, acrylamide, a N-substituted acrylamide, a styrene, or vinylacetate.

The term “polyacrylamide resin” means a polymer comprising monomeric units derived from acrylamide, a N-substituted acrylamide and mixtures thereof. Said polymer may be an acrylamide co-polymer which further comprises monomeric units derived from compounds other than those cited above, such as, for example, acrylic acid, a mono-acrylate, methacrylic acid, a mono-methacrylate, cyanoacrylic acid, a mono-cyanoacrylate, acrylonitrile and mixtures thereof.

The term “polymaleimide resin” means a polymer comprising monomeric units derived from maleic anhydride, a N-substituted acrylamide and mixtures thereof.

The term “liquid composition” means that the composition flows under its own weight. In particular, a liquid composition may exhibit a viscosity between 1,000 and 40,000 centipoises, said viscosity being measured at 23° C. using a Brookfield viscometer (for viscosities of less than 10,000 centipoises, the measurements are taken with the R5 module at a speed of 30 rpm and for viscosities of greater than 10,000 centipoises, the measurements are taken with the R6 module at a speed of 20 rpm). Such a viscosity allows the application of the composition especially with a roller commonly known as a fabric roller or a brush to form 0.5 to 2 mm thick layers in one or more applications.

The term “one-component composition” means a ready-to-use composition. In particular, the composition may be applied on its own by the final user, i.e. by the worker who will apply the waterproof coating. Such a ready-to-use composition is conventionally known in the art as a “one-component” composition, as opposed to a “two-component composition” which requires the addition of a catalyst, hardener or another reactive agent before use or which must be applied in a limited time span (a few hours) after being mixed.

The term “curable composition” means a composition comprising a polymer having functional groups capable of forming covalent bonds with chain extenders, cross-linkers or other polymer molecules to form a cross-linked polymer network.

The term “moisture curable composition” means a composition that is cured under the action of air moisture or —OH containing groups.

The term “stable composition” means a composition that can be stored for a minimum of 4 months without any phase separation or mass gelling being observed.

The term “non-toxic composition” means a composition that contains less than 1% by weight of free diisocyanate monomers, according to directive 67/548/EEC (30th ATP directive 2008/58/EC), the free diisocyanate monomer content being measured by gas chromatography coupled to a mass spectrometer (according to standard EN ISO 17734-1/2006).

The term “solvent” means any solvent that is conventionally used in curable compositions, said solvent being inert toward the reagents contained in the composition, liquid at room temperature and having a boiling point below 240° C.

### DETAILED DESCRIPTION OF THE INVENTION

Prepolymer

The prepolymer of the invention is represented by formula (1):

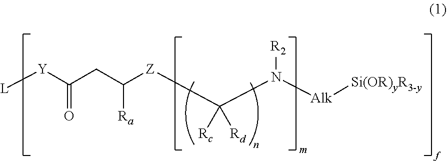

wherein

L is a plurivalent radical;

Y is O or NR_{b}, preferably Y is O;

Z is S or NR₁, preferably Z is NR₁;

Rₐ is hydrogen;

R_{b} is hydrogen;

or Rₐ forms a cycle with R_{b}, preferably a succinimide;

each R_{c} is independently H, a C1-C20 alkyl, a C6-C12 aryl or C6-C12 alkylaryl, preferably H, methyl, ethyl, phenyl or benzyl, more preferably H or methyl;

each R_{d} is independently H, a C1-C20 alkyl, a C6-C12 aryl or a C6-C12 alkylaryl, preferably H, methyl, ethyl, phenyl or benzyl, more preferably H or methyl;

or one R_{d} forms a cycle with R₁, another R_{d} forms a cycle with R₂ and the remaining R_{d} are hydrogen or C1-C20 alkyl, preferably one R_{d} forms a piperidine with R₁, another R_{d} forms a piperidine with R₂ and the remaining R_{d} are hydrogen or C1-C20 alkyl;

R₁ is H, a C1-C20 alkyl optionally substituted by OH or NRₑR_{f}, a C6-C12 aryl or a C6-C12 alkylaryl, preferably R₁ is H, methyl, ethyl, butyl, cyclohexyl, phenyl or benzyl;

R₂ is H, a C1-C20 alkyl optionally substituted by OH or NRₑR_{f}, a C6-C12 aryl or a C6-C12 alkylaryl, preferably R₂ is H, methyl, ethyl, butyl, cyclohexyl, phenyl or benzyl;

or R₁ and R₂ form a cycle, preferably a piperazine optionally substituted by one or more groups selected from C1-C20 alkyl, C6-C12 aryl and C6-C12 alkylaryl;

or R₁ forms a cycle with one R_{d} and R2 forms a cycle with another R_{d}, preferably R₁ forms a piperidine with one R_{d} and R2 forms a piperidine with another R_{d};

Rₑ and R_{f} are independently H, a C1-C20 alkyl, a C6-C12 aryl or a C6-C12 alkylaryl;

Alk is a linear or branched C1-C20 alkylene, preferably Alk is methylene, propylene or —(CH₂)—(CHCH₃)—(CH₂)—;

each R is independently C1-C20 alkyl, preferably R is methyl or ethyl, more preferably R is methyl;

f is 2 to 6, preferably 2 to 4, more preferably 2 to 3;

m is 0 or 1;

n is 2, 3, 4, 5, 6, 7, 8 or 9, preferably n is 2;

y is 0, 1, 2 or 3, preferably y is 2 or 3.

In particular, groups Y and Rₐ may be selected to form a moiety selected from propanoate, propanamide, and succinimide.

As such, the prepolymers of the present invention may be represented by one of the following formulae (1a)-(1c):

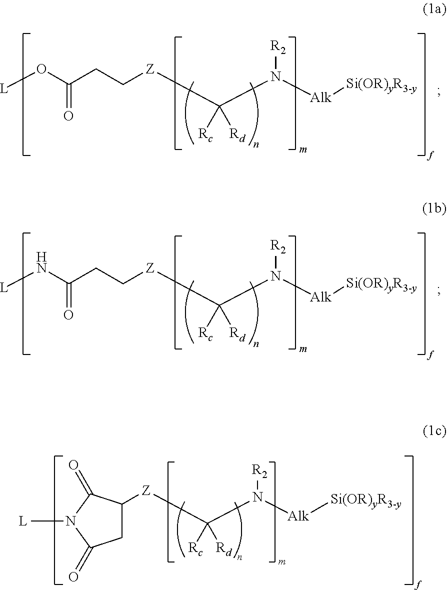

wherein L, Z, R_{c}, R_{d}, R, R₂, Alk, f, m, n and y are as defined above.

In a preferred embodiment, the prepolymer of the invention is represented by formula (1a).

Group L can be any group. In particular, L may be a plurivalent hydrocarbyl radical containing 1 to 500 carbon atoms. Said plurivalent hydrocarbyl radical may be linear or branched, cyclic or acyclic, saturated or unsaturated, aliphatic or aromatic. Said plurivalent hydrocarbyl radical may be interrupted by one or more functional groups selected from ether, thioether, disulfide, ester, amide, carbamate, urea, dimethylsiloxane and mixtures thereof. One or more of the carbon atoms of said plurivalent hydrocarbyl radical may be replaced by a nitrogen atom or an isocyanurate group. Said plurivalent hydrocarbyl radical may be substituted by one or more substituents selected from halogen, alkyl, aryl, hydroxy, alkoxy, haloalkyl, cyano, carboxyl, oxo, formyl, ester, imido, amido, a tertiary amino group, nitro, sulfonyl and mixtures thereof.

In particular, L may be a plurivalent hydrocarbyl radical derived from an alkane;

a polyether, preferably a polypropylene glycol, a copolymer of ethylene glycol and propylene glycol or a polytetramethylene glycol;

a polyester, preferably a polyester based on a fatty acid dimer;

a polyurethane;

an isocyanurate;

an epoxy acrylate, preferably a bio-based acrylated epoxidized resin;

a polydimethyl siloxane;

a poly(alkyl (meth)acrylate);

a polybutadiene;

a polysulfide;

and combinations thereof.

Preferably, L is a plurivalent hydrocarbyl radical derived from a polyurethane, a polybutadiene, a polyether and combinations thereof. More preferably, L is a plurivalent hydrocarbyl radical comprising 3 to 250 carbon atoms, in particular 30 to 200 carbon atoms, derived from a polyurethane, a polybutadiene, a polyether and combinations thereof.

In a first embodiment of the invention Z is S or NR₁ and m is 0.

In said first embodiment Z is preferably NR₁;

R₁ is H, a C1-C20 alkyl optionally substituted by OH or NRₑR_{f}, a C6-C12 aryl or a C6-C12 alkylaryl;

preferably R₁ is H, methyl, ethyl, butyl, cyclohexyl, phenyl or benzyl; and Rₑ and R_{f} are independently H, a C1-C20 alkyl, a C6-C12 aryl or a C6-C12 alkylaryl.

In a second embodiment of the invention Z is NR₁ and m is 1.

In said second embodiment, R₁ and R₂ are independently C1-C20 alkyl, C6-C12 aryl or C6-C12 alkylaryl, preferably methyl, ethyl, phenyl or benzyl, more preferably methyl;

or R₁ and R2 form a cycle, preferably a piperazine, more preferably an unsubstituted piperazine;

or R₁ forms a cycle with one R_{d} and R₂ forms a cycle with another R_{d} and the remaining R_{d} are hydrogen or C1-C20 alkyl, preferably R₁ forms a piperidine with one R_{d} and R₂ forms a piperidine with another R_{d} and the remaining R_{d} are hydrogen or C1-C20 alkyl.

In said second embodiment, the following group (2) of formula (1) of the prepolymer:

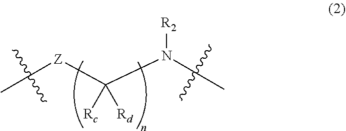

may be represented by one of the following formulae (2a)-(2d):

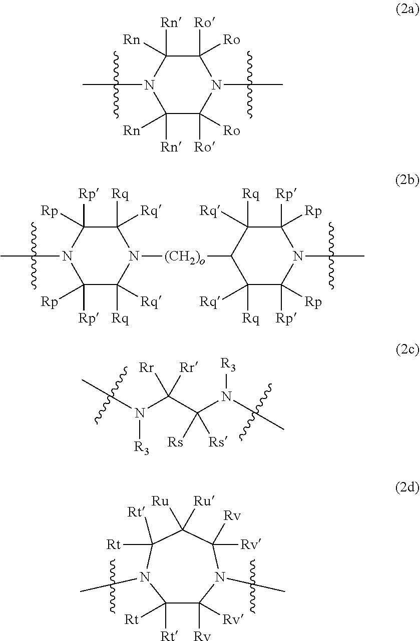

wherein

R₃ is C1-C20 alkyl, C6-C12 aryl or C6-C12 alkylaryl, preferably methyl or ethyl, phenyl or benzyl, more preferably methyl;

each Rₙ, Rₙ′, Rₒ, Rₒ′, Rₚ, Rₚ′, R_{q}, R_{q}′, Rᵣ, Rᵣ′, Rₛ, Rₛ′, Rₜ, Rₜ′, Rᵤ, Rᵤ′, Rᵥ and Rᵥ′ is independently selected from H, C1-C20 alkyl, C6-C12 aryl or C6-C12 alkylaryl, preferably H, methyl, ethyl, phenyl or benzyl, more preferably H or methyl;

o is 0, 1, 2 or 3;

preferably group (2) is represented by formula (2a), more preferably group (2) is represented by formula (2a) and Rₙ, Rₙ′, Rₒ and Rₒ′ are all H.

In said first and second embodiments, L may be a linear or branched, cyclic or acyclic, saturated or unsaturated, aliphatic or aromatic, divalent, trivalent, tetravalent, pentavalent or hexavalent, hydrocarbyl radical comprising 1-500 carbon atoms, said radical being optionally interrupted by one more functional groups selected from ether, ester, amide, carbamate, urea and mixtures thereof, said radical optionally having one or more carbon atoms replaced by an isocyanurate group, said radical being optionally substituted by one or more substituents selected from halogen, hydroxy, alkoxy and mixtures thereof.

In said first and second embodiment, L may preferably be represented by one of formulae (La)-(Ll3):

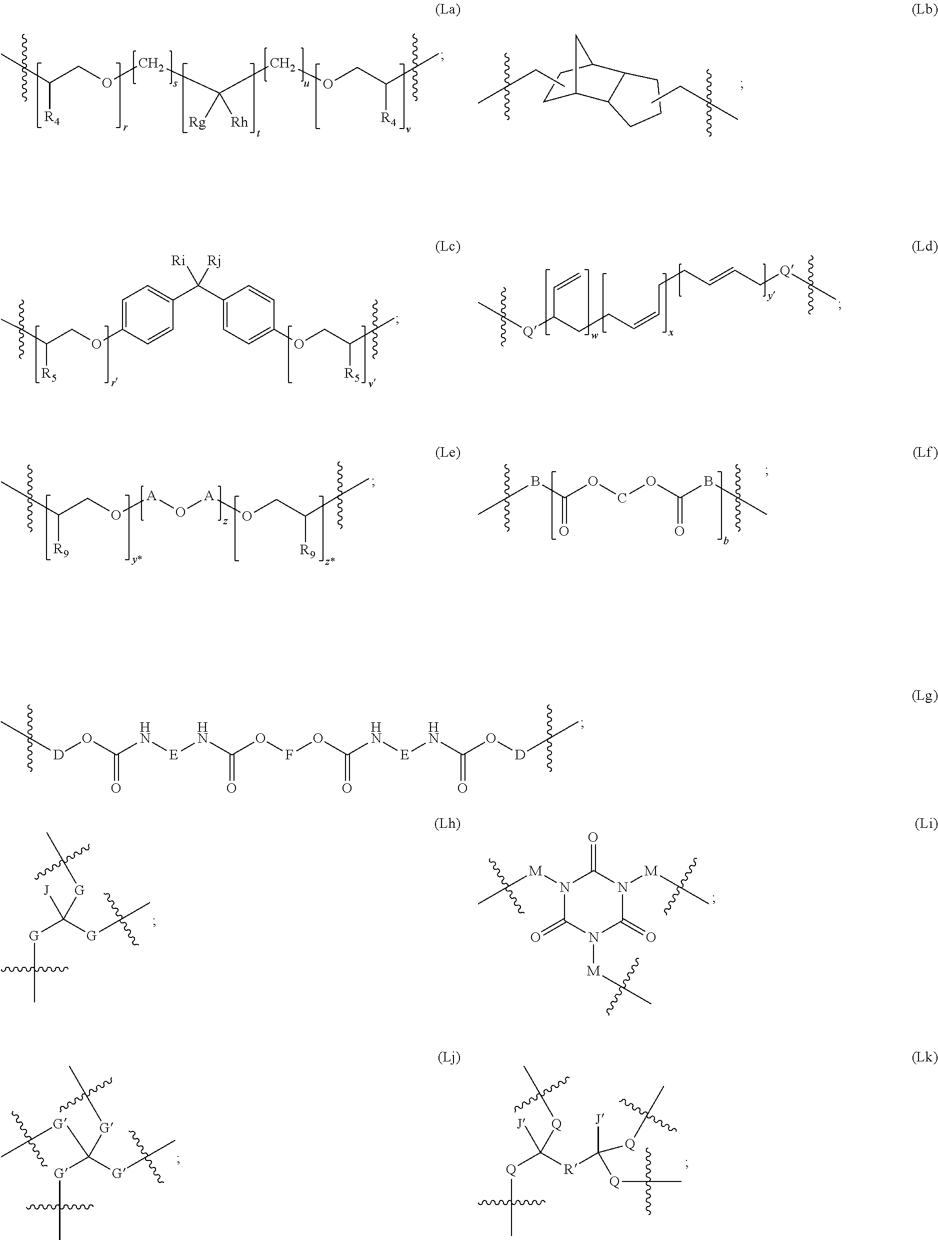

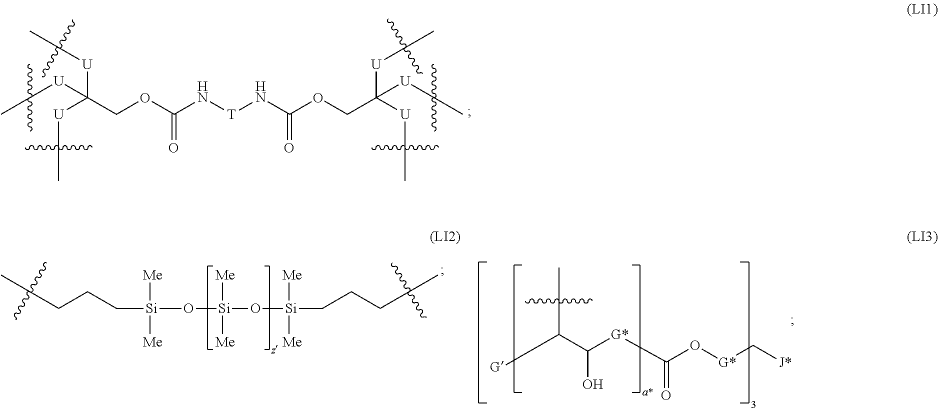

wherein

R_{g} and Rₕ are independently H or C1-C20 alkyl, preferably H, methyl or ethyl, more preferably H or methyl;

Rᵢ and Rⱼ are independently H, halogen, C1-C20 alkyl, C1-C20 haloalkyl, C6-C12 aryl or C6-C12 alkylaryl; preferably C1-C20 alkyl, more preferably methyl;

each R₄, R₅ and R₉ is independently H or methyl; preferably R₅ is methyl and preferably R₅ is methyl;

each A is independently a linear or branched, cyclic or acyclic, saturated or unsaturated alkylene comprising 2 to 20 carbon atoms;

each B is independently a linear or branched, cyclic or acyclic, saturated or unsaturated alkylene comprising 2 to 20 carbon atoms;

C is a linear or branched, cyclic or acyclic, saturated or unsaturated alkylene comprising 4 to 100 carbon atoms optionally interrupted by one or more ether and/or ester functional groups;

each D is independently a linear or branched, cyclic or acyclic, saturated or unsaturated alkylene comprising 2 to 20 carbon atoms;

each E is independently a linear or branched, cyclic or acyclic, saturated or unsaturated alkylene comprising 4 to 100 carbon atoms optionally interrupted by one or more ether and/or carbamate functional groups;

each F is independently a linear or branched, cyclic or acyclic, saturated or unsaturated alkylene comprising 4 to 100 carbon atoms optionally interrupted by one or more ether and/or carbamate functional groups;

each G is independently a linear or branched alkylene comprising 0 to 100 carbon atoms optionally interrupted by one or more ether and/or ester functional groups;

each G′ is independently a linear or branched alkylene comprising 0 to 100 carbon atoms optionally interrupted by one or more ether and/or ester functional groups;

each G* is independently a linear or branched alkylene comprising 0 to 100 carbon atoms J, J′ and J* are independently H or a linear or branched alkyl comprising 1 to 20 carbon atoms, optionally substituted by hydroxy or alkoxy;

J′ is H or a linear or branched alkyl comprising 1 to 20 carbon atoms, optionally substituted by hydroxy or alkoxy;

each M is independently a linear or branched, cyclic or acyclic alkylene comprising 1 to 20 carbon atoms optionally interrupted by one or more ether and/or carbamate functional groups;

each Q is independently a linear or branched alkylene comprising 0 to 100 carbon atoms optionally interrupted by one or more ether functional groups;

each Q* is independently a linear or branched alkylene comprising 0 to 100 carbon atoms optionally interrupted by one or more ether and/or functional groups;

R′ is a linear or branched alkylene comprising 1 to 20 carbon atoms optionally interrupted by one or more ether functional groups;

T is a linear or branched, cyclic or acyclic, saturated or unsaturated alkylene comprising 4 to 100 carbon atoms optionally interrupted by one or more ether and/or carbamate functional groups;

each U is independently a linear or branched alkylene comprising 0 to 100 carbon atoms optionally interrupted by one or more ether and/or ester functional groups;

b is 1 to 10;

s, t and u are independently 0 to 10;

r, r′, v, v′, w, x, y′, y*, z and z* are independently 0 to 50; preferably (x+y′+w) is between 20 to 70 and preferably z is 5 to 50

z′ is 5 to 150;

each a* is independently 1, 2 or 3 with the proviso that that formula (Ll3) does not comprise more than six a* units.

In said first and second embodiment, L may more preferably be represented by one of the following formulae (Lb), (Ld) and (Lm)-(Ly):

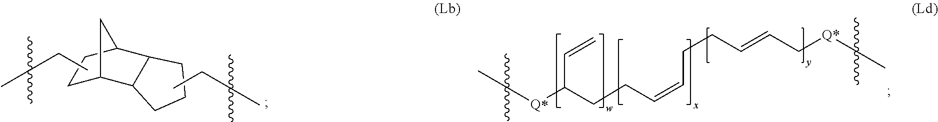

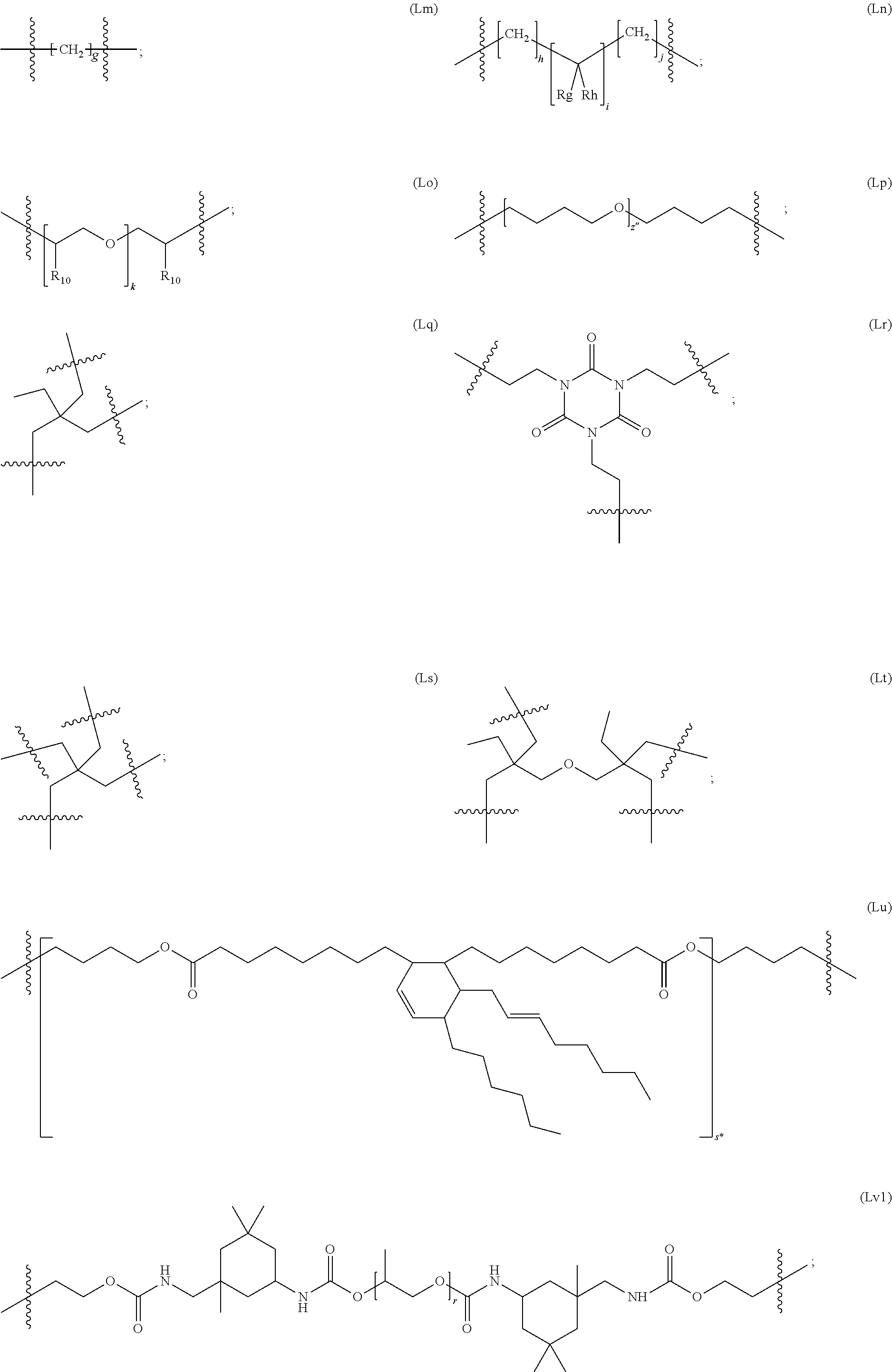

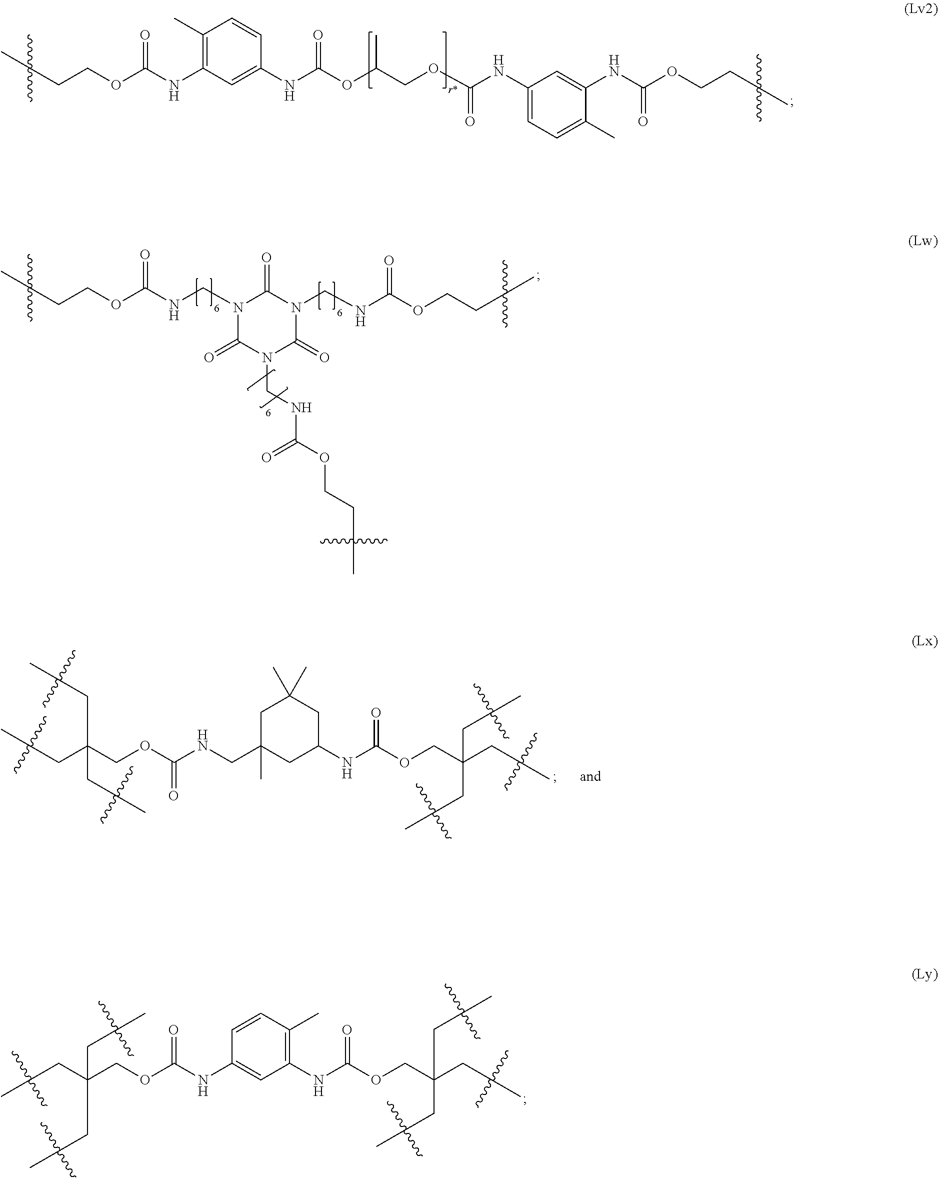

wherein

Q*, w, x and y′ are as defined above;

each R₁₀ is independently H or methyl; preferably methyl;

R_{g} and Rₕ are independently H or C1-C20 alkyl, preferably H, methyl or ethyl, more preferably H or methyl;

g is 2 to 20, preferably 3 to 12, more preferably 4 to 10;

h, i and j are independently 0 to 10, preferably 1 to 4, more preferably 1 to 2;

k is 2 to 100; preferably k is between 40 to 80; more preferably between 55 and 75; for example k is 68

r and r* are independently 1 to 70; preferably r is 14 to 70 and preferably r* is 14 to 70;

s* is 1 to 20;

z″ is 5 to 50, preferably 8 to 30, more preferably 10 to 20 or z″ is 5 to 70, preferably 45 to 65, for example z″ is 54.

The L group may also be a compound resulting from reduction of fatty acid dimers or a hydrogenated polybutadienes:

Examples of fatty acid dimers include but are not limited to compounds of general formula (Lz) resulting from reduction of fatty acid dimers such as Pripol® compounds sold by Croda Company:

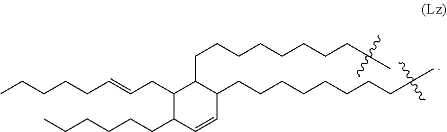

Examples of hydrogenated polybutadienes include, but are not limited to, compounds of general formula (Lz′):

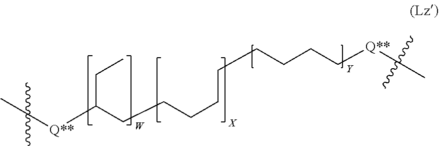

wherein

each Q** is independently a linear or branched alkylene comprising 0 to 100 carbon atoms optionally interrupted by one or more ether and/or ester functional groups,

(W+X+Y) is between 20 and 70.

Preferably, the L group of the first and second embodiment is represented by one of formulae (Ld) and (Lv).

Alternatively, in said first and second embodiment, L may be represented by the following formula (Lprep)

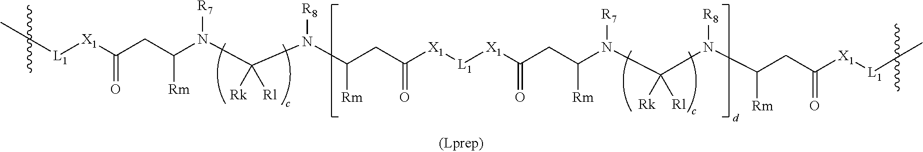

wherein

X₁ is O or NRₙ, preferably X₁ is 0;

each L₁ is independently a plurivalent radical, preferably each L₁ has a molecular weight above 500 g·mol⁻¹;

Rₖ is hydrogen;

Rₗ is hydrogen;

or one Rₗ forms a cycle with R7, another Rₗ forms a cycle with Rₛ and the remaining Rₗ are hydrogen,

preferably one Rₗ forms a piperidine with R₇, another Rₗ forms a piperidine with R₈ and the remaining Rₗ are hydrogen;

Rₘ is hydrogen;

Rₙ is hydrogen;

or Rₘ forms a cycle with Rₙ, preferably a succinimide;

R₇ and R₈ are independently C1-C20 alkyl, C6-C12 aryl or C6-C12 alkylaryl, preferably methyl, ethyl, phenyl or benzyl, more preferably methyl;

or R₇ and R₈ form a cycle, preferably a piperazine, more preferably a non-substituted piperazine;

or R₇ forms a cycle with one Rₗ and Rₛ forms a cycle with another Rₗ, preferably R₇ forms a piperidine with one Rₗ and R₈ forms a piperidine with another R₁;

c is 2, 3, 4, 5, 6, 7, 8 or 9;

0<d≤20, preferably 0.5≤d≤10, more preferably 1≤d≤6, even more preferably 1≤d≤4.

In all of the preceding embodiments, the R group of the prepolymer may, in particular, be methyl or ethyl and y may be 2 or 3. Preferably, R may be methyl and y may be 2 or 3.

The prepolymer of the invention may exhibit a number average molecular weight (Mn) of 400 to 10,000, preferably 800 to 6,000, more preferably 1,000 to 5,000. The number average molecular weight may be determined by steric exclusion chromatography (SEC) or nuclear magnetic resonance (NMR).

The prepolymer of the invention may be obtained according to the method described below.

Method for Preparing the Prepolymer of the Invention

The prepolymer of the invention may be obtained by a Michael addition. Michael addition is a chemical reaction in which an enolate anion (nucleophile) reacts with an activated α,β-unsaturated carbonyl compound (electrophile) according to a 1,4-addition. A wide range of functional groups possess sufficient nucleophilicity to react in a Michael addition, such as amines (aza-addition) and thiols (thio-addition). Michael addition is one of the most versatile reactions in organic synthesis with its click chemistry nature, no byproducts, and the mild conditions required for the reaction. An example of a Michael addition is represented in the scheme below:

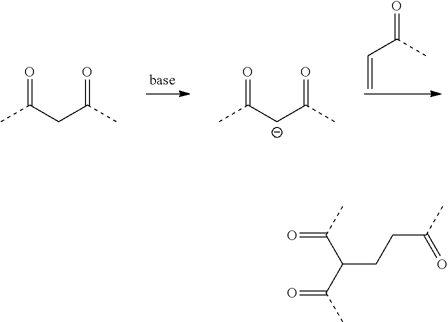

The first step of a Michael reaction is transforming a ketone to an enolate, or nucleophile, through deprotonation due to the addition of a base. This negative charge initiates 1,4-addition on an α,β-unsaturated carbonyl compound which is then protonated and forms the final product. The reaction is thermodynamically controlled as the donors are active methylenes and the acceptors are activated olefins.

In accordance with an aspect, a Michael addition reaction can be employed to manufacture silyl-terminated polymers useful for obtaining one-component moisture curable sealants, coatings or adhesives. The method involves reacting a multifunctional α,β-unsaturated carbonyl compound with an aminosilane or a mercaptosilane. The aminosilane or mercaptosilane are Michael donors and the multifunctional α,β-unsaturated carbonyl compound is a Michael acceptor.

The method for preparing a prepolymer according to the invention comprises reacting an electrophile of formula (3) or (Prep) with a silane of formula (4):

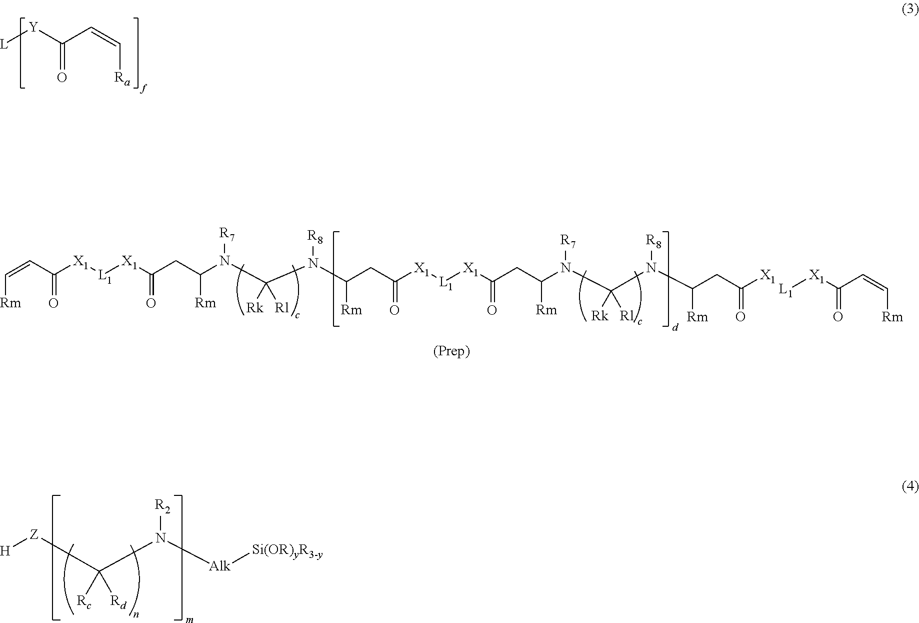

wherein L, L₁, Y, Z, X₁, R, Rₐ, R_{c}, R_{d}, Rₖ, Rₗ, Rₘ, R₂, R₇, R₈, Alk, c, d, f, m, n and y are as defined above for the prepolymer;

when Z is S or NR₁ and R₁ is not H, the molar ratio between the hydrogens on the amine or thiol reactive groups of the silane and the α,β-unsaturated carbonyl groups of the electrophile is from 0.8 to 1.2, preferably 0.9 to 1.1, more preferably 0.95 to 1.05;

when Z is NH, the molar ratio between the hydrogens on the amine reactive groups of the silane and the α,β-unsaturated carbonyl groups of the electrophile is from 1.8 to 2.2, preferably 1.9 to 2.1, more preferably 1.95 to 2.05.

The electrophile of formula (3) or (Prep) may be represented by one of the following formulae (3a)-(3c) or (PrepA)-(PrepC):

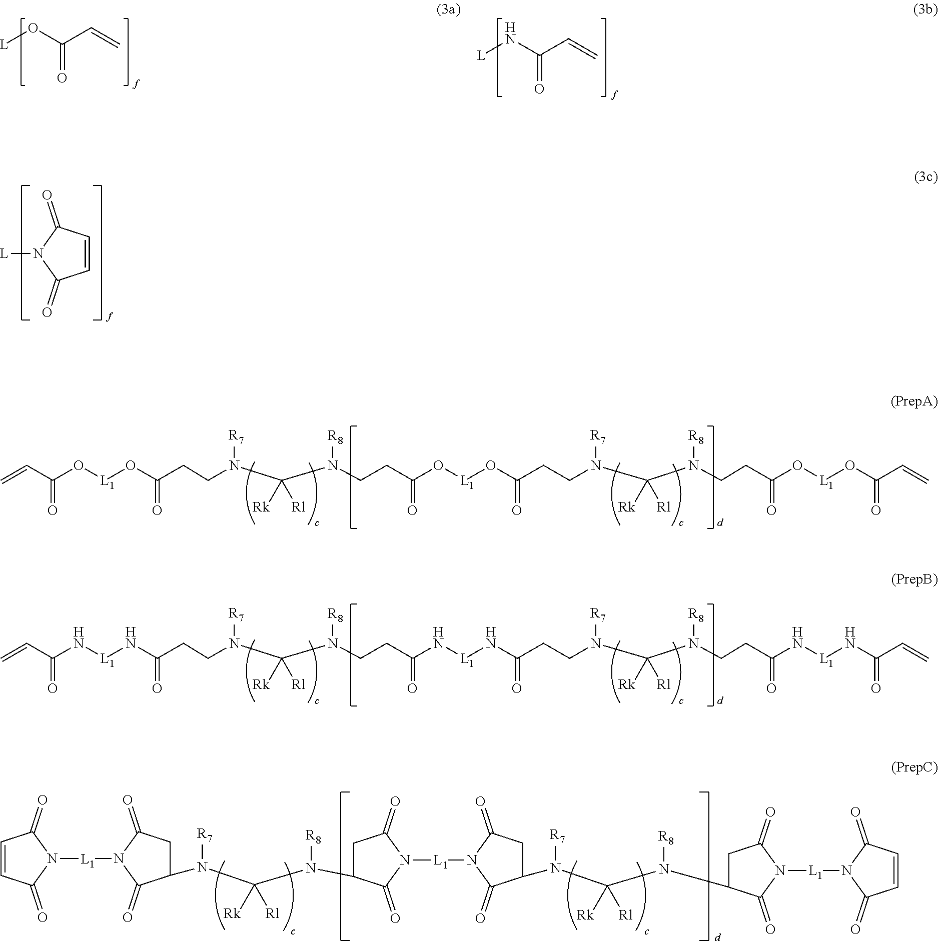

wherein L, L₁, Rₖ, Rₗ, R₇, R₈, c, d and f are as defined above for the prepolymer.

In a preferred embodiment, the electrophile may be represented by formula (3a) or (PrepA).

In formulae (3a)-(3c), L may preferably be represented by one of formulae (La)-(Ll3) as defined above for the first and second embodiment of the prepolymer, more preferably L may be represented by one of formulae (Ld) and (Lm)-(Ly), even more preferably L may be represented by one of formulae (Ld) and (Lv).

Examples of electrophiles of formula (3a) include a poly(propylene glycol) diacrylate, a poly(ethylene glycol) diacrylate, butanediol diacrylate, 1,6-hexanediol diacrylate, an ethoxylated 1,6-hexanediol diacrylate, 1,10-decanediol diacrylate, 3-methyl-1,5-pentanediol diacrylate, neopentylglycol diacrylate, a propoxylated neopentylglycol diacrylate, dimethylol tricyclodecane diacrylate, an ethoxylated bisphenol A diacrylate, trimethylol propane triacrylate, an ethoxylated trimethylol propane triacrylate, a propoxylated trimethylol propane triacrylate, tris[2-(acryloyloxy)ethyl] isocyanurate, pentaerythritol triacrylate, glycerol triacrylate, a propoxylated glycerol triacrylate, pentaerythritol tetracrylate, an ethoxylated pentaerythritol tetracrylate, an epoxydized soybean oil (AESO) and a polycaprolactone triacrylate.

Another example of an electrophile of formula (3a) is an esterdiol diacrylate (available under reference SR 606A by Sartomer) having the following formula:

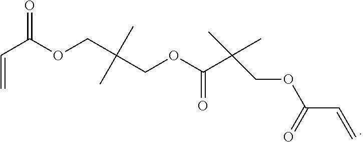 [SMILES: C=CC(=O)OCC(C)(C)COC(=O)C(C)(C)COC(=O)C=C]

Another example of an electrophile of formula (3a) is an aliphatic urethane acrylate oligomer (available under reference CN 9002 by Sartomer) having the following formula:

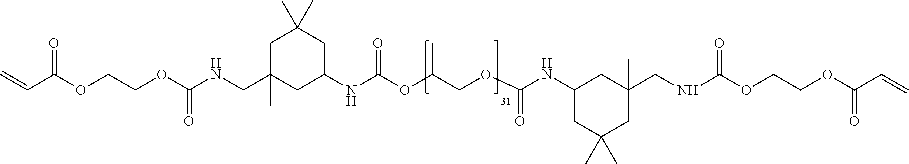

or an aromatic urethane oligomer (available under reference CN 9761 by Sartomer) having the following formula:

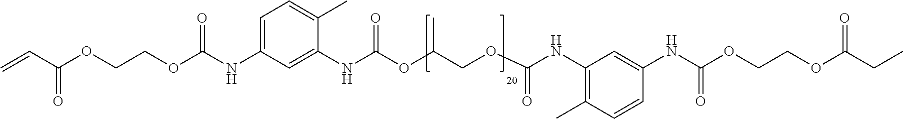

Another example of an electrophile of formula (3a) is a polybutadiene diacrylate (available under reference SR 307 by Sartomer) having the following formula:

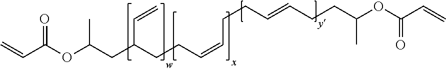

wherein w+x+y′=40.

Electrophiles of formula (Prep) and (PrepA)-(PrepC) are described in patent application number EP19305656.1 filed on May 24, 2019 by the Applicants.

An example of a suitable electrophile of formula (PrepA) is represented below:

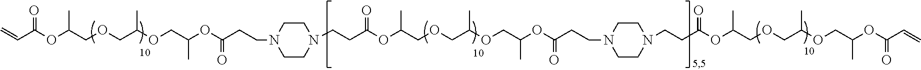

The silane of formula (4) may be represented by one of the following formulae (4a)-(4d):

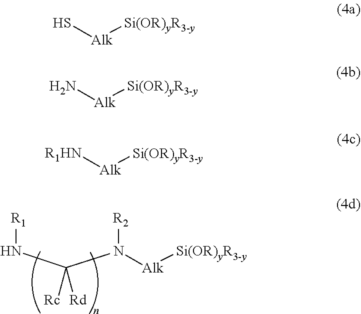

wherein R, R_{c}, R_{d}, R₁, R₂, Alk, n and y are as defined above for the prepolymer.

Examples of suitable silanes with their commercial references and CAS numbers are represented below:

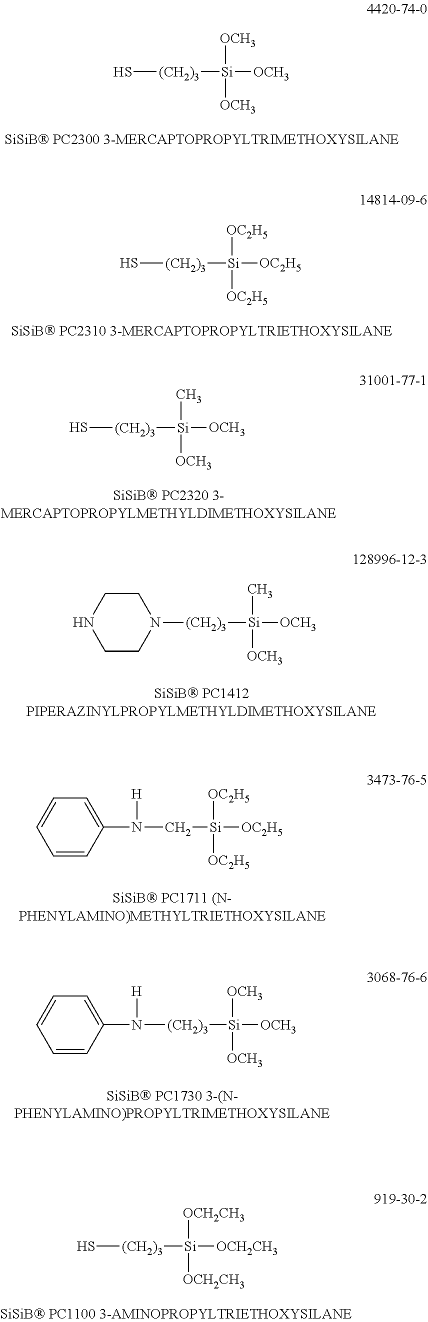

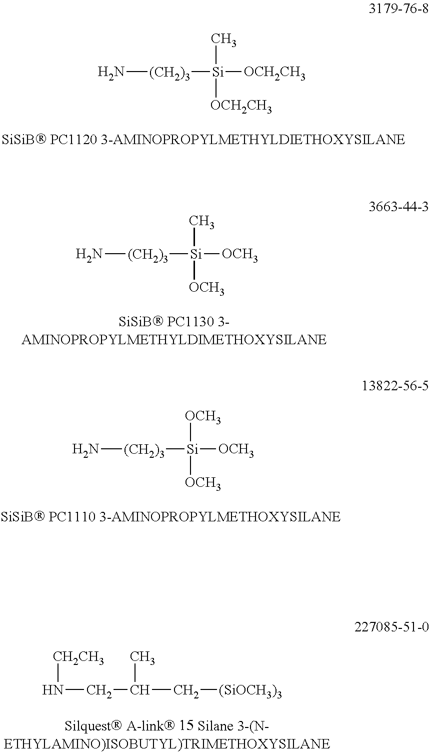

In the method of the invention, the reaction between the electrophile and the silane may be carried out in the presence or in the absence of a solvent. Preferably, the reaction between the electrophile and the silane may be carried out in the absence of a solvent.

In the method of the invention, the reaction between the electrophile and silane may be carried out in the presence or in the absence of a catalyst. When the electrophile reacts with an aminosilane (Z is NR₁), the reaction between the electrophile and the aminosilane may be carried out in the absence of catalyst. When the electrophile reacts with a mercaptosilane (Z is S), the reaction between the electrophile and the mercaptosilane may be carried out in the presence of a catalyst. In particular, said catalyst may be a base, more particularly 1,4-diazabicyclo[2.2.2]octane (DABCO) or 1,8-diazabicyclo[5.4.0]undec-7-ene (DBU). When a catalyst is present, the amount of the catalyst may be from 0.1 to 5%, in particular 0.5 to 4%, more particularly 1 to 3%, the percentage being a molar percentage based on the number of moles of SH groups of the mercaptosilane.

In the method of the invention, the reaction between the electrophile and the silane may be carried out at a temperature of 10 to 60° C., in particular 15 to 50° C., more particularly 20 to 40° C., during a time of 5 min to 4 h, in particular 15 min to 2 h, more particularly 30 min to 1 h.

The completion of the reaction may be monitored by Fourier-transform infrared (FT IR) spectroscopy. FT IR spectroscopy works by sending infrared radiation through a chemical sample, where some radiation is absorbed into the sample and some passes through. The radiation that is absorbed is converted to vibrational energy, which produces a unique signal that identifies the compound. During the Michael addition, the carbon-carbon double bond of the electrophile is transformed into a carbon-carbon single bond. Once the FT IR signal of the carbon-carbon double bond disappears, the reaction may be considered as finished. The reaction may alternatively be monitored by Proton Nuclear Magnetic Resonance (¹H-NMR). Once the α,β-unsaturated carbonyl group has reacted, the signals of the ethylenic protons (between 5.8 and 6.5 ppm) are no longer visible and a new signals relative to single bonds CH2-CH2 are present.

Composition Comprising a Prepolymer

The composition according to the invention comprises the prepolymer of the invention and an additive. The composition may further optionally comprise a resin and/or a catalyst.

The prepolymer introduced in the composition of the invention is as defined above. The composition may comprise a mixture of prepolymers according to the invention. The composition may comprise a mixture of a prepolymer according to the invention and a silyl-terminated prepolymer not according to the present invention.

The amount of the prepolymer according to the invention in the composition may be from 20 to 60%, in particular 25 to 55%, more particularly 30 to 50%, by weight based on the weight of the composition.

The additive introduced in the composition of the invention are selected from a plasticizer, a filler, an adhesion promoter, a pigment or dye, a UV-absorber, an antioxidant, a UV-stabilizer, a moisture scavenger, a fungicide, a biocide, a root-penetration preventer, a fire-retardant, a rheology modifier, an oxygen barrier and mixtures thereof.

Examples of suitable plasticizers are aromatic oils, such as diisopropyl naphthalene (Ruetasolv® DI) or NYTEX® 820; esters of polycarboxylic acids with linear or branched aliphatic alcohols, such as phthalates and adipates, for example dioctyl phthalate (DOP), diisodecyl phthalate (DIDP), diisononyl phthalate (DINP), butylbenzyl phthalate and di(2-ethylhexyl)adipate (DEHA); esters of polyols with linear or branched carboxylic acids, such as trimethyl pentanediol diisobutyrate (TXIB); alkylsulfonic acid phenylesters, such as Mesamoll®; and mixtures thereof.

Examples of suitable fillers are mineral or organic fillers, such as calcium carbonate, silica, talc, dolomite, kaolin, carbon black, titanium dioxide, and mixtures thereof. Preferably, said filler is calcium carbonate.

Fillers derived from recycling can also be used (lignin, recycled fibers, ground polymer materials, coke, ground cement materials).

Examples of suitable biocides and fungicides are 2-octyl-2H-isothiazol-3-one (OIT) in diisododecylphthalate (Fungitrol® PA10), N-(Trichloromethylthio) phthalimide (Fungitrol® 11), 3-iodo-2-propynyl butylcarbamate (IPBC) (Fungitrol® 0450 or Preventol® MP100).

An example of a suitable root-penetration preventer is 2-(4-chloro-2-methylphenoxy)-propionic acid octyl ester (Preventol® B5).

Examples of suitable UV-absorbers and antioxidants are Irganox® 565 (2,4-Bis(octylthio)-6-(4-hydroxy-3,5-di-tert-butylanilino)-1,3,5-triazine), IONOL® CP (2,6-Di-tert-butyl-4-methylphenol), Tinuvin® 1130 (2-(2-hydroxyphenyl)-benzotriazole), Tinuvin® 400 (2-hydroxyphenyl-s-triazine).

Examples of suitable UV-stabilizers are Tinuvin® 292 ((Bis(1,2,2,6,6-pentamethyl-4-piperidyl) sebacate), Tinuvin® 123 (Bis(1-octyloxy-2,2,6,6-tetramethyl-4-piperidyl) sebacate).

Examples of suitable moisture scavenger and adhesion promoters are silanes, such as vinyltrimethoxysilane (Geniosil® XL 10) and N-(2-Aminoethyl)-3-aminopropyltrimethoxysilane (Geniosil® GF91).

Examples of suitable rheology modifiers are a hydrophobically modified alkali swellable emulsion (HASE) such as Acrysol® TT 935 and Acrysol® DR-110 ER; a cellulose or cellulose derivative such as CMC, HMC, HPMC; a polysaccharide such as carrageenan, pullulan, konjac, and alginate; a clay such as attapulgite, bentonite and montmorillonite; a gum such as guar gum, xanthan gum, cellulose gum, locust bean gum, and acacia gum.

Examples of suitable fire retardants are borates, such as colemanite, halogenated compounds (tris(chloropropyl)phosphate=TCPP or tetrabromobisphenol-A=TBBA or Hexabromocyclododecane=HBCD), triaryl phosphate, melamine (non-halogenated flame retardant), alumina trihydrate, DOPO (9,10-dihydro-9-oxa-10-phosphaphenanthrene-10-oxide=Polyphlox® 3710).

An example of a suitable oxygen barrier is a wax, such as paraffin wax (Sasolwax® 5603).

The amount of the additive in the composition may be from 40 to 80%, in particular 45 to 75%, more particularly 50 to 70%, by weight based on the weight of the composition.

The composition may comprise a resin. The resin that may optionally be introduced in the composition may be selected from a multifunctional epoxy resin, a multifunctional isocyanate resin, a multifunctional (meth)acrylate resin, a multifunctional acrylamide resin, a multifunctional maleimide resin, a poly(meth)acrylate resin, a polyacrylamide resin, a polymaleimide resin, and mixtures thereof. Preferably, the resin is a multifunctional epoxy resin, more preferably a diepoxide resin derived from a bisphenol. Even more preferably, the resin is bisphenol A diglycidyl ether epoxy resin which has the following formula:

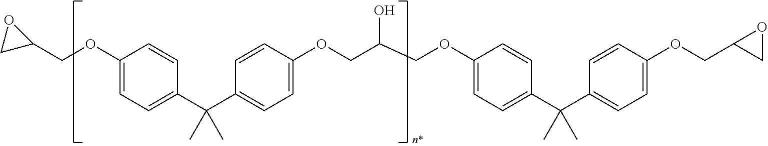

wherein n* is typically from 0 to 25.

The amount of resin in the composition may be from 0 to 20%, in particular 2 to 15%, more particularly 5 to 10%, by weight based on the weight of the composition.

The composition may comprise a catalyst. Said catalyst may be introduced in the composition to promote cross-linking of the silyl groups of the prepolymers in the presence of atmospheric moisture. The catalyst that may optionally be introduced in the composition may be selected from a tertiary amine, an organometallic compound, an acid, an anhydride, and mixtures thereof. Preferably, the catalyst is a metal carboxylate (tin, zinc, iron, lead, copper or titanium carboxylate such as dibutyltin dilaurate (DBTDL), dioctyltin dilaurate, dioctyltin acetylacetonate, copper acetylacetonate, isopropyl triisostearoyl titanate), a carboxylic or sulfonic acid (stearic acid, palmitic acid, oleic acid, 4-dodecylbenzene sulfonic acid, dinonylnaphthalene disulfonic acid, p-toluenesulfonic acid (p-TSA), methanesulfonic acid), a tertiary cyclic amine (1,8-diazabicyclo[5.4.0]undec-7-ene (DBU), 1,5-Diazabicyclo[4.3.0]non-5-ene (DBN), 1,4-diazabicyclo[2.2.2]octane (DABCO)) or an anhydride (methyltetrahydrophthalic anhydride (MHTPA), methylnadic anhydride and methylsuccinic anhydride). Even more preferably, the catalyst is DBU or DBTDL.

The amount of catalyst in the composition may be from 0 to 2%, in particular 0.01 to 1%, more particularly 0.1 to 0.8%, by weight based on the weight of the composition.

In one embodiment, the composition of the invention comprises the following constituents, the % being % by weight based on the weight of the composition:

30-50% of the prepolymer of the invention;

10-30% of a plasticizer, in particular diisodecyl phthalate (DIDP);

30-50% of a filler, in particular calcium carbonate;

0-2% of a moisture scavenger, in particular vinyltrimethoxysilane;

0-5% of an adhesion promoter, in particular N-(2-Aminoethyl)-3-aminopropyltrimethoxysilane;

0-2% of a catalyst, in particular dibutyltin dilaurate (DBTDL);

0-10% of a pigment or dye.

The composition of the invention may advantageously be a liquid one-component moisture curable composition. Also, the composition of the invention may be a stable composition. Further, the composition of the invention may be a non-toxic composition. Additionally, the composition of the invention may have a low solvent content, i.e. less than 5%, in particular less than 2%, more particularly less than 1%, by weight of solvent based on the weight of the composition, or the composition may be substantially free of any solvent.

The composition of the invention may be used to obtain a sealant, coating or adhesive.

Sealant, Coating or Adhesive

The sealant, coating or adhesive of the invention is obtained by curing the composition according to the present invention.

The curing may be carried out rapidly under ambient conditions, in the presence of atmospheric moisture. In one embodiment, the curing may be carried out at a temperature of −10 to 50° C., in particular −5 to 45° C., more particularly 0 to 40° C., during a time of 1 to 72 h, in particular 2 to 30 h, more particularly 3 to 24 h.

The sealant, coating or adhesive according to the invention may exhibit a glass transition temperature of −120 to 80° C., preferably −100 to 60° C., more preferably −80 to 50° C.

The sealant, coating or adhesive according to the invention may exhibit excellent mechanical properties. As such, the sealant, coating or adhesive may exhibit a tensile strength at 20° C. of 0.1 to 100 MPa, preferably 1 to 50 MPa, more preferably 5 to 20 MPa. Further, the sealant, coating or adhesive may exhibit an elongation at break at 20° C. of 10 to 1,000%, preferably 50 to 800%, more preferably 100 to 600%.

Use of the Composition

The invention also relates to the use of the composition according to the invention for producing a sealant, coating or adhesive, especially a leaktight sealant or coating, which has good mechanical strength, is resistant to UV, to oxidation aging, to water and to chemical attack, and which does not have any surface defects or adhesion defects (bubbles, swelling or exudation). The sealants or coatings may be circulable and are particularly suitable for use in an unprotected exterior medium as leaktight sealants or coatings. The sealants, coatings or adhesives obtained have an entirely satisfactory water uptake, i.e. less than 8% after 28 days of immersion in water at 20° C. The sealants, coatings or adhesives obtained by the use of the composition according to the invention can cover horizontal, oblique, vertical or rough surfaces and/or surfaces comprising singular points.

The composition of the invention may be used for waterproofing exterior or interior traffic-bearing horizontal surfaces, for making flashings, or for renovating roofs.

In one embodiment, the composition of the invention may be used for waterproofing exterior circulable horizontal surfaces, such as, for example, balconies, stadiums, terraces, car parks, building courtyards, etc.

In another embodiment, the composition of the invention may be used for making upstand flashings, i.e. for making a waterproof coating between a bituminous surface and a vertical wall or a singular point, or alternatively for renovating roofs.

In another embodiment, the composition of the invention may be used to bind two elements together.

The invention will be described in greater detail with the aid of the examples that follow, which are given for purely illustrative purposes.

### EXAMPLES

Measuring Methods:

In the examples, the following methods were used to determine the glass transition temperature (Tg), the ultimate tensile strength, the Young's modulus and the elongation at break.

Glass Transition Temperature

The glass transition temperature is determined on a dry material at least 7 days after its preparation by differential scan calorimetry (DSC). The DSC analyses were performed on a 10 mg sample using a Q200 apparatus from TA Instruments. The following cycles were applied:

Cycle 1: temperature increase from room temperature to 170° C. at 10° C./min and remaining at 170° C. for 5 min;

Cycle 2: temperature decrease to −80° C. at 20° C./min and remaining at −80° C. for 5 min;

Cycle 3: temperature increase to 170° C. at 10° C./min.

The Tg was measured during the third cycle.

Mechanical Analysis:

The mechanical analyses were determined on a dry material 7 days after its preparation according to standard NF EN ISO 527, February 2012 on an extensometer from Instron. The following parameters were used:

tensile speed: 100 mm/min

temperature: 23° C.

test specimen: dumbbell-shaped type 5.

Materials:

In the examples, the following materials were used:

CN 9002 (aliphatic polyurethane diacrylate) having a number average molecular weight of about 5,000 g·mol⁻¹ was obtained from Sartomer;

SR 307 (polybutadiene diacrylate) having a number average molecular weight of about 2,240 g·mol⁻¹ was obtained from Sartomer;

CN 9761 (aromatic polyurethane diacrylate) having a number average molecular weight of about 1,800 g·mol⁻¹ was obtained from Sartomer;

(3-mercaptopropyl)methyldimethoxysilane was obtained from Sigma-Aldrich;

(3-mercaptopropyl)trimethoxysilane was obtained from Momentive under the reference Silquest® A-189;

[3-(1-piperazinyl)propyl]methyl dimethoxysilane was obtained from Gelest under the reference SIP6828.4;

DBU (1,8-diazabicyclo[5.4.0]undec-7-ene-catalyst) was obtained from Sigma-Aldrich;

PPGDA (polypropyleneglycol diacrylate) having a number average molecular weight of 840 g·mol⁻¹ was obtained from Sigma-Aldrich;

Piperazine was obtained from BASF;

Calcium carbonate (filler) was obtained from Omya under reference Omya® BLH;

DIDP (diisodecyl phthalate-plasticizer) was obtained from Flag S.p.A.;

N-(2-Aminoethyl)-3-aminopropyltrimethoxysilane (adhesion promoter) was obtained from Wacker under reference Geniosil® GF 91;

Vinyltrimethoxysilane (moisture scavenger) was obtained from Wacker under reference Geniosil® XL 10; DBTDL (dibutyltin dilaurate) was obtained from LANXESS.

### Example 1: Preparation of a Silyl Terminated Prepolymer of Formula (I)

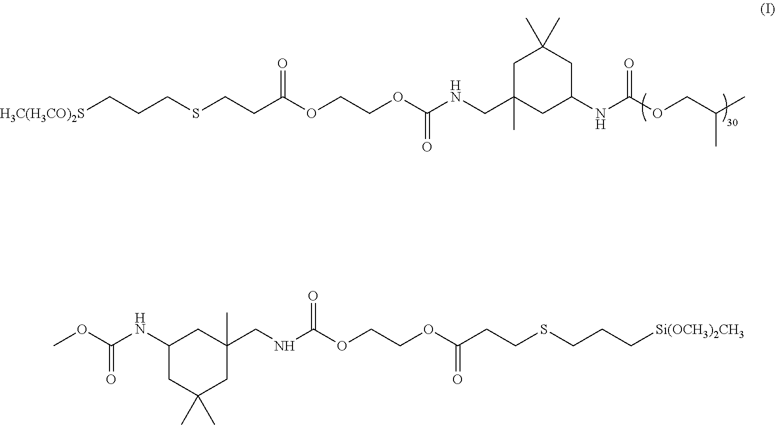

CN 9002 (40.2 g, 0.008 mol), (3-mercaptopropyl)methyldimethoxysilane (2.89 g, 0.016 mol) and DBU (25 mg, 1% by mole with respect to SH) were mixed in a reactor under nitrogen atmosphere, without any solvent. The mixture was stirred at 70° C. for 1 hour. The reaction was considered complete when the NMR peaks corresponding to the ethylenic protons «CH₂=CH₂» of the acrylate disappeared (between 5.8 ppm and 6.5 ppm). The resulting product was a colorless viscous liquid. NMR analysis confirmed that the structure of resulting product corresponded to formula (I).

NMR⁻¹H: (δ ppm, CDCl₃) 0.12-0.20 (6H), 0.70-0.80 (4H), 0.80-1.40 (260H), 2.57 (4H), 2.66 (4H), 2.80 (4H), 2.84-3.00 (4H), 3.20-3.85 (218H), 4.10-5.00 (17H).

### Example 2: Preparation of a Silyl Terminated Prepolymer of Formula (II)

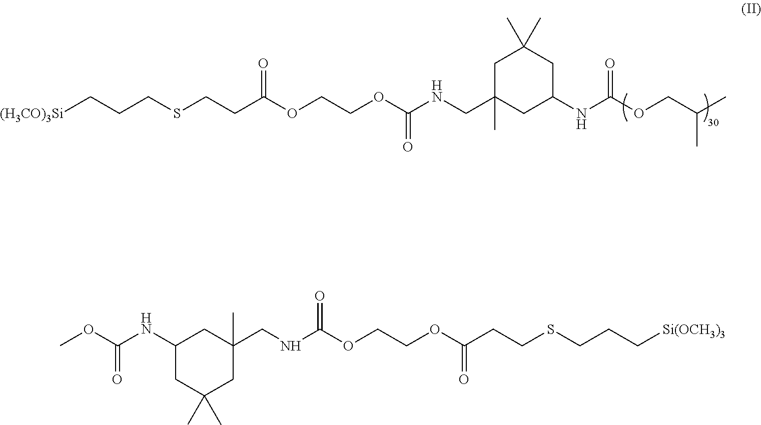

The prepolymer of formula (II) was obtained according to example 1 by reacting CN 9002 (40.0 g, 0.008 mol) with (3-mercaptopropyl)trimethoxysilane (3.14 g, 0.016 mol) and DBU (30 mg, 1% by mole with respect to SH) at 70° C. for 1 hour. The resulting product was a colorless viscous liquid. NMR analysis confirmed that the structure of resulting product corresponded to formula (II).

NMR⁻¹H: (δ ppm, CDCl₃) 1.00-1.35 (148H), 1.80 (2H), 2.30-2.60 (46H), 2.62-2.76 (18H), 2.82-2.92 (8H), 3.25-3.75 (140H), 4.95-5.15 (8H).

### Example 3: Preparation of a Silyl Terminated Prepolymer of Formula (III)

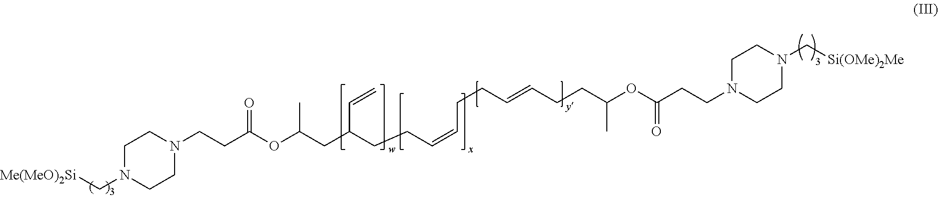

wherein w+x+y=40

SR 307 (40.0 g, 0.018 mol) and [3-(1-piperazinyl)propyl]methyl dimethoxysilane (8.30 g, 0.036 mol) were mixed in a reactor under nitrogen atmosphere, without any catalyst or solvent. The mixture was stirred at 60° C. for 3 hours. The reaction was considered complete when the NMR peaks corresponding to the ethylenic protons «CH₂═CH₂» of the acrylate disappeared (between 5.8 ppm and 6.5 ppm). The resulting product was a brown viscous liquid. NMR analysis confirmed that the structure of resulting product corresponded to formula (III).

NMR⁻¹H: (δ ppm, CDCl₃) 0.13 (6H), 0.62 (4H), 0.75-1.75 (77H), 1.80-2.30 (77H), 2.35 (4H), 2.40-2.65 (17H), 2.69 (4H), 2.84-3.00 (3H), 3.52 (12H), 4.65-5.20 (51H), 5.25-5.95 (51H).

### Example 4: Preparation of a Silyl Terminated Prepolymer of Formula (IV)

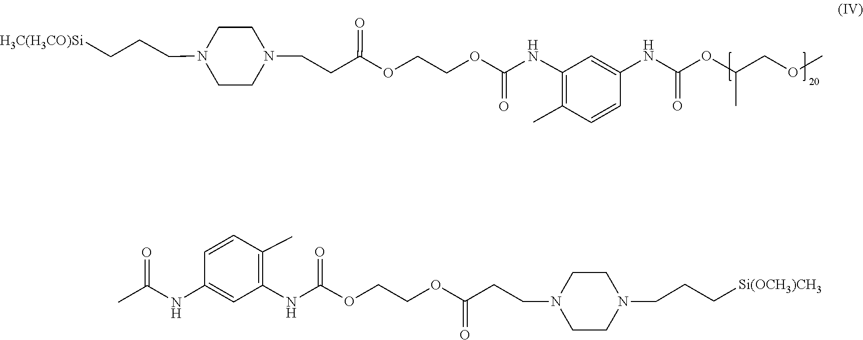

The prepolymer of formula (IV) was obtained according to example 3 by reacting CN 9761 (40.0 g, 0.022 mol) and [3-(1-piperazinyl)propyl]methyl dimethoxysilane (10.30 g, 0.044 mol) at 60° C. for 3 hours. The resulting product was a yellow viscous liquid. NMR analysis confirmed that the structure of resulting product corresponded to formula (IV).

NMR⁻¹H: (δ ppm, CDCl₃) 0.13 (6H), 0.60 (4H), 1.00-1.40 (68H), 1.56 (4H), 1.83 (4H), 2.13-2.24 (6H), 2.25-2.65 (21 H), 2.72 (4H), 3.20-3.82 (76H), 3.85-4.45 (8H), 5.03 (2H), 6.35-7.90 (6H).

### Example 5: Preparation of a Silyl Terminated Prepolymer of Formula (VI)

Step 1) Preparation of an Acrylate Terminated Prepolymer of Formula (V):

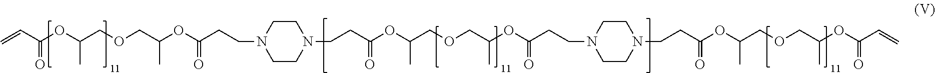

Piperazine (5 g, 0.058 mol) and PPGDA (58.5 g, 0.070 mol) were mixed in a 100 mL flask without any catalyst or solvent. The mixture was stirred at 80° C. for 1 hour. The resulting product was a colorless liquid with low viscosity that does not contain any residual piperazine. NMR analysis confirmed that the resulting product was a prepolymer of PPGDA and piperazine with terminal acrylate groups. The number average molecular weight was determined by NMR.

NMR-¹H: (δ ppm, CDCl₃) 1.00-1.30 (204H), 2.30-2.58 (50H), 2.60-2.73 (21H), 3.30-3.80 (206H), 5.05 (11H), 5.8-6.5 (6H)

The average number of repeating units was 3. The number average molecular weight was determined to be about 5,000 g·mol⁻¹.

Step 2) Michael Addition to Obtain a Silyl Terminated Prepolymer of Formula (VI):

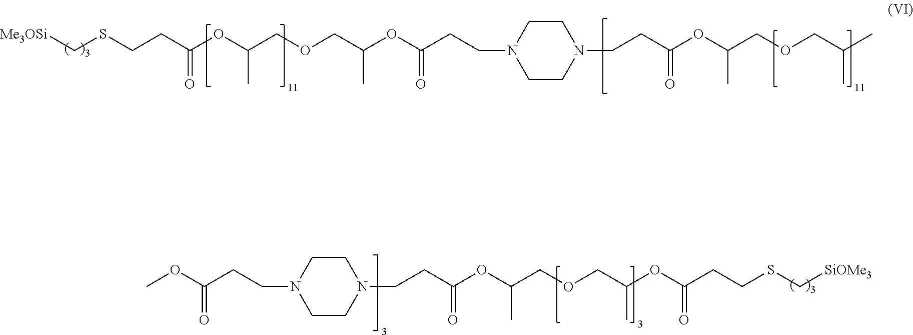

The acrylate terminated prepolymer of formula (V) obtained in step 1 (58.3 g, 11.7 mmol) was mixed with (3-mercaptopropyl)trimethoxysilane (4.6 g, 23.5 mmol) and DBU (20 mg, 1% by mole with respect to SH) in a reactor under nitrogen atmosphere. The mixture was stirred at 70° C. for 4 hours. The reaction was considered complete when the NMR peaks corresponding to the ethylenic protons «CH₂═CH₂)» of the acrylate disappeared (between 5.8 ppm and 6.5 ppm). The resulting product was a colorless liquid with low viscosity. NMR analysis confirmed that the structure of resulting product corresponded to formula (VI).

NMR⁻¹H: (δ ppm, CDCl₃) 0.75 (4H), 1.00-1.30 (204H), 1.70 (4H), 2.35-2.85 (80H), 3.30-3.80 (210H), 5.05 (11H).

### Example 6: Preparation of a Silyl Terminated Prepolymer of Formula (VII)

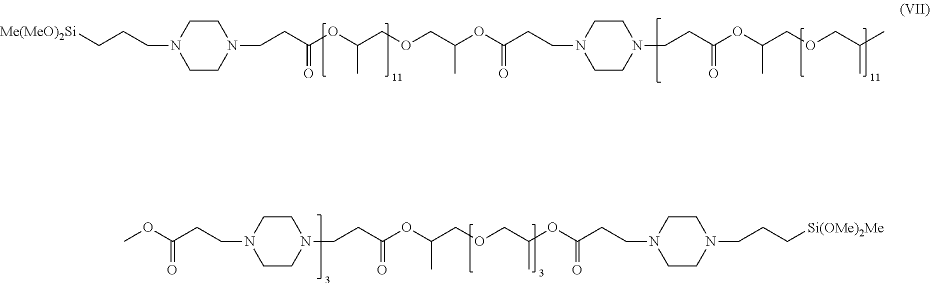

The acrylate terminated prepolymer of formula (V) obtained in step 1 of Example 5 (40.1 g, 8 mmol) was mixed with [3-(1-piperazinyl)propyl] methyldimethoxysilane (3.7 g, 16 mmol) in a reactor under nitrogen atmosphere without any solvent or catalyst. The mixture was stirred at 60° C. for 3 hours. The resulting product was a colorless liquid with low viscosity. NMR analysis confirmed that the structure of resulting product corresponded to formula (VII).

NMR⁻¹H: (δ ppm, CDCl₃) 0.12 (6H), 0.61 (4H), 1.05-1.40 (244H), 1.57 (4H), 2.31-2.77 (114H), 3.25-3.75 (237H), 5.05 (12H).

### Example 7: Preparation of a Silyl Terminated Prepolymer of Formula (VIII)

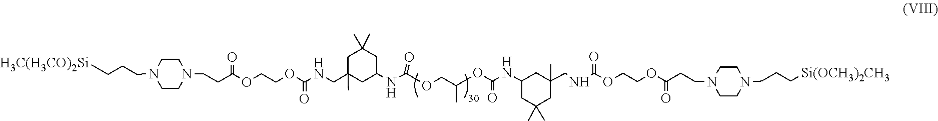

The prepolymer of formula (VIII) was obtained according to example 3 by reacting CN 9002 (40.3 g, 0.008 mol) and [3-(1-piperazinyl)propyl]methyl dimethoxysilane (3.7 g, 0.016 mol) at 70° C. for 1 hour. The resulting product was a colorless viscous liquid. NMR analysis confirmed that the structure of resulting product corresponded to formula (VIII).

NMR⁻¹H: (δ ppm, CDCl₃) 0.12 (6H), 0.77 (4H), 0.85-1.35 (238H), 1.52-1.82 (16H), 1.96 (18H), 2.33 (4H), 2.40-2.60 (16H), 2.72 (4H), 2.84-3.00 (4H), 3.20-3.85 (200H), 4.10-5.00 (18H)

### Example 8: Preparation of a Silyl Terminated Prepolymer of Formula (IX)

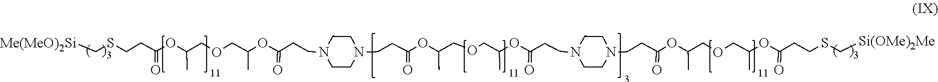

The acrylate terminated prepolymer of formula (V) obtained in step 1 of Example 5 (39.9 g, 8 mmol) was mixed with (3-mercaptopropyl)methyldimethoxysilane (2.9 g, 16 mmol) and DBU (20 mg) in a reactor under nitrogen atmosphere without any solvent. The mixture was stirred at 70° C. for 1 hour. The resulting product was a colorless liquid with low viscosity. NMR analysis confirmed that the structure of resulting product corresponded to formula (IX).

NMR⁻¹H: (δ ppm, CDCl₃) 0.12 (6H), 0.74 (4H), 0.85-1.35 (260H), 1.60-1.85 (15H), 2.35-2.75 (101H), 2.78 (4H), 3.20-3.85 (248H), 5.05 (13H)

### Example 9: Preparation of Sealant Composition

Compositions 1 to 8 were prepared using the ingredients and the respective amounts in grams listed in the following table:

| | Composition 1 | Composition 2 | Composition 3 | Composition 4 |
|---|---|---|---|---|
| Silyl terminated | Prepared in | Prepared in | Prepared in | Prepared in |
| prepolymer | Example 1 | Example 2 | Example 3 | Example 4 |
| | (50 g) | (59.9 g) | (40.6 g) | (40.2 g) |
| Filler | Omya ® BLH | Omya ® BLH | Omya ® BLH | Omya ® BLH |
| | (62.7 g) | (75.4 g) | (50.2 g) | (50.3 g) |
| Plasticizer | DIDP | DIDP | DIDP | DIDP |
| | (26.9 g) | (32.2 g) | (21.6 g) | (21.8 g) |
| Adhesion promoter | Geniosil ® GF 91 | Geniosil ® GF 91 | Geniosil ® GF 91 | Geniosil ® GF 91 |
| | (3.6 g) | (4.4 g) | (3.0 g) | (2.9 g) |
| Moisture scavenger | Geniosil ® XL10 | Geniosil ® XL10 | Geniosil ® XL10 | Geniosil ® XL10 |
| | (1.8 g) | (2.2 g) | (1.5 g) | (1.6 g) |
| Catalyst | DBTDL | DBTDL | DBTDL | DBTDL |
| | (0.6 g) | (0.7 g) | (0.6 g) | (0.5 g) |
| | Composition 5 | Composition 6 | Composition 7 | Composition 8 |
| Silyl terminated | Prepared in | Prepared in | Prepared in | Prepared in |
| prepolymer | Example 5 | Example 6 | Example 7 | Example 8 |
| | (39.9 g) | (40.1 g) | (40.1 g) | (40.0 g) |
| Filler | Omya ® BLH | Omya ® BLH | Omya ® BLH | Omya? ® BLH |
| | (50.2 g) | (50.1 g) | (50.3 g) | (50.1 g) |
| Plasticizer | DIDP | DIDP | DIDP | DIDP |
| | (21.5 g) | (21.4 g) | (21.5 g) | (21.6 g) |
| Adhesion promoter | Geniosil ® GF 91 | Geniosil ® GF 91 | Geniosil ® GF 91 | Geniosil ® GF 91 |
| | (2.8 g) | (2.9 g) | (2.9 g) | (2.8 g) |
| Moisture scavenger | Geniosil ® XL10 | Geniosil ® XL10 | Geniosil ® XL10 | Geniosil ®XL10 |
| | (1.5 g) | (1.5 g) | (1.4 g) | (1.5 g) |
| Catalyst | DBTDL | DBTDL | DBTDL | DBTDL |
| | (0.6 g) | (0.6 g) | (0.6 g) | (0.6 g) |

The silyl terminated prepolymer and plasticizer were mixed in a disperser and stirred for 10 minutes. The filler, adhesion promoter and moisture scavenger were then added and the mixture was stirred for 15 minutes. The catalyst was then added and the mixture was stirred for 10 minutes. The composition was casted on a plate in order to obtain a uniform film having a thickness of about 1 mm and was left to dry during 7 days.

The thermal and mechanical properties of the resulting sealants are listed in the table below:

| | Composition 1 | Composition 2 | Composition 3 | Composition 4 |
|---|---|---|---|---|
| Ultimate Tensile strength (MPa) | 0.42 (+/−0.01) | 0.57 (+/−0.03) | 0.68 (+/−0.03) | 0.63 (+/−0.01) |
| Young's Modulus (MPa) | 0.81 (+/−0.10) | 1.48 (+/−0.30) | 1.79 (+/−0.15) | 0.95 (+/−0.30) |
| Elongation at break (%) | 210 (+/−4) | 107 (+/−6) | 70 (+/−3) | 213 (+/−19) |
| Tg (° C.) | −66 | −65 | −57 | −58 |
| | Composition 5 | Composition 6 | Composition 7 | Composition 8 |
| Ultimate Tensile strength (MPa) | 0.55 (+/−0.04) | 0.76 (+/−0.03) | 0.80 (+/−0.01) | 0.50 (+/−0.06) |
| Young's Modulus (MPa) | 1.64 (+/−0.40) | 1.67 (+/−0.14) | 1.97 (+/−0.30) | 0.97 (+/−0.21) |
| Elongation at break (%) | 73 (+/−10) | 175 (+/−8) | 200 (+/−15) | 180 (+/−5) |
| Tg (° C.) | −62 | −61 | −67 | −61 |

1. A prepolymer represented by formula (1): 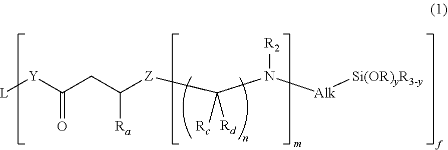
wherein
Y is O or NR_{b}, preferably Y is O;
Z is S or NR₁, preferably Z is NR₁;
Rₐ is hydrogen;
R_{b} is hydrogen;
or Rₐ forms a cycle with R_{b}, preferably a succinimide;
each R_{c} is independently H, a C1-C20 alkyl, a C6-C12 aryl or C6-C12 alkylaryl, preferably H, methyl, ethyl, phenyl or benzyl, more preferably H or methyl;
each R_{d} is independently H, a C1-C20 alkyl, a C6-C12 aryl or a C6-C12 alkylaryl, preferably H, methyl, ethyl, phenyl or benzyl, more preferably H or methyl;
or one R_{d} forms a cycle with R₁, another R_{d} forms a cycle with R₂ and the remaining R_{d} are hydrogen or C1-C20 alkyl, preferably one R_{d} forms a piperidine with R₁, another R_{d} forms a piperidine with R₂ and the remaining R_{d} are hydrogen or C1-C20 alkyl;
R₁ is H, a C1-C20 alkyl optionally substituted by OH or NRₑR_{f}, a C6-C12 aryl or a C6-C12 alkylaryl, preferably R₁ is H, methyl, ethyl, butyl, cyclohexyl, phenyl or benzyl;
R₂ is H, a C1-C20 alkyl optionally substituted by OH or NRₑR_{f}, a C6-C12 aryl or a C6-C12 alkylaryl, preferably R₂ is H, methyl, ethyl, butyl, cyclohexyl, phenyl or benzyl;
or R₁ and R₂ form a cycle, preferably a piperazine optionally substituted by one or more groups selected from C1-C20 alkyl, C6-C12 aryl and C6-C12 alkylaryl;
or R₁ forms a cycle with one R_{d} and R₂ forms a cycle with another R_{d}, preferably R₁ forms a piperidine with one R_{d} and R₂ forms a piperidine with another R_{d};
Rₑ and R_{f} are independently H, a C1-C20 alkyl, a C6-C12 aryl or a C6-C12 alkylaryl;
Alk is a linear or branched C1-C20 alkylene, preferably Alk is methylene, propylene or —(CH₂)—(CHCH₃)—(CH₂)—;
each R is independently C1-C20 alkyl, preferably R is methyl or ethyl, more preferably R is methyl;
f is 2 to 6, preferably 2 to 4, more preferably 2 to 3;
m is 0 or 1;
n is 2, 3, 4, 5, 6, 7, 8 or 9, preferably n is 2;
y is 0, 1, 2 or 3, preferably y is 2 or 3 and wherein
L is represented by one of the following formulae (La)-(Ll13): 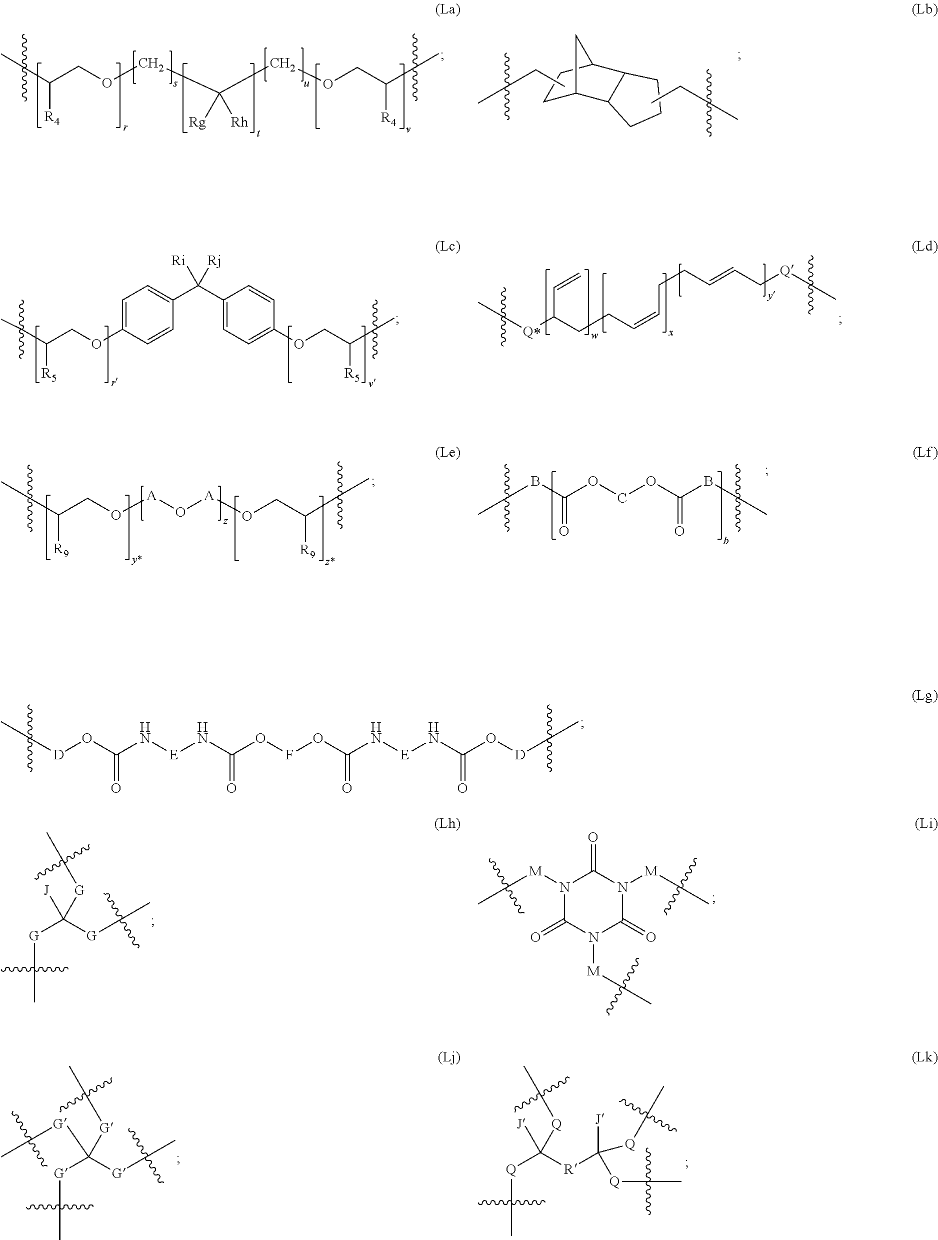 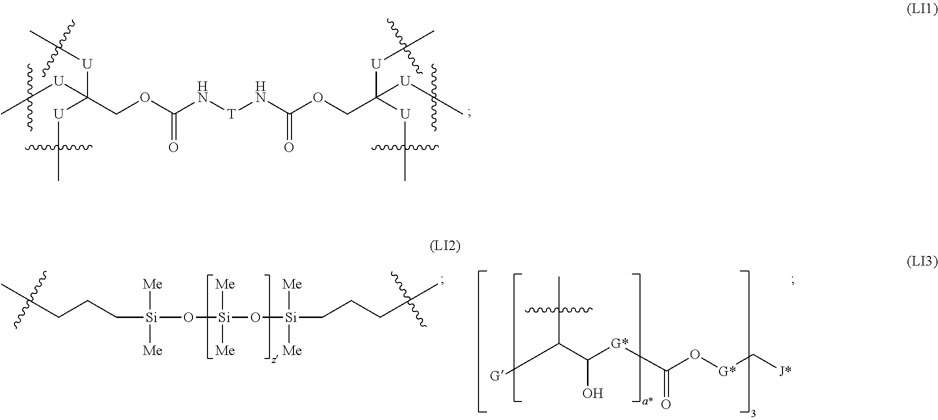
wherein
R_{g} and Rₕ are independently H or C1-C20 alkyl, preferably H, methyl or ethyl, more preferably H or methyl;
Rᵢ and Rⱼ are independently H, halogen, C1-C20 alkyl, C1-C20 haloalkyl, C6-C12 aryl or C6-C12 alkylaryl; preferably C1-C20 alkyl, more preferably methyl;
each R₄, R₅ and R₉ is independently H or methyl; preferably R₅ is methyl and preferably R₉ is methyl;
each A is independently a linear or branched, cyclic or acyclic, saturated or unsaturated alkylene comprising 2 to 20 carbon atoms;
each B is independently a linear or branched, cyclic or acyclic, saturated or unsaturated alkylene comprising 2 to 20 carbon atoms;
C is a linear or branched, cyclic or acyclic, saturated or unsaturated alkylene comprising 4 to 100 carbon atoms optionally interrupted by one or more ether and/or ester functional groups;
each D is independently a linear or branched, cyclic or acyclic, saturated or unsaturated alkylene comprising 2 to 20 carbon atoms;
each E is independently a linear or branched, cyclic or acyclic, saturated or unsaturated alkylene comprising 4 to 100 carbon atoms optionally interrupted by one or more ether and/or carbamate functional groups;
each F is independently a linear or branched, cyclic or acyclic, saturated or unsaturated alkylene comprising 4 to 100 carbon atoms optionally interrupted by one or more ether and/or carbamate functional groups;
each G is independently a linear or branched alkylene comprising 0 to 100 carbon atoms optionally interrupted by one or more ether and/or ester functional groups;
each G′ is independently a linear or branched alkylene comprising 0 to 100 carbon atoms optionally interrupted by one or more ether and/or ester functional groups;
each G* is independently a linear or branched alkylene comprising 0 to 100 carbon atoms
J, J′ and J* are independently H or a linear or branched alkyl comprising 1 to 20 carbon atoms, optionally substituted by hydroxy or alkoxy;
J′ is H or a linear or branched alkyl comprising 1 to 20 carbon atoms, optionally substituted by hydroxy or alkoxy;
each M is independently a linear or branched, cyclic or acyclic alkylene comprising 1 to 20 carbon atoms optionally interrupted by one or more ether and/or carbamate functional groups;
each Q is independently a linear or branched alkylene comprising 0 to 100 carbon atoms optionally interrupted by one or more ether functional groups;
each Q* is independently a linear or branched alkylene comprising 0 to 100 carbon atoms optionally interrupted by one or more ether and/or ester functional groups;
R′ is a linear or branched alkylene comprising 1 to 20 carbon atoms optionally interrupted by one or more ether functional groups;
T is a linear or branched, cyclic or acyclic, saturated or unsaturated alkylene comprising 4 to 100 carbon atoms optionally interrupted by one or more ether and/or carbamate functional groups;
each U is independently a linear or branched alkylene comprising 0 to 100 carbon atoms optionally interrupted by one or more ether and/or ester functional groups;
b is 1 to 10;
s, t and u are independently 0 to 10;
r, r′, v, v′, w, x, y′, y*, z and z* are independently 0 to 50; preferably (x+y′+w) is between 20 to 70 and preferably z is 5 to 50;
z′ is 5 to 150;
each a* is independently 1, 2 or 3 with the proviso that formula (Ll3) does not comprise more than six a* units
Or L is represented by one of the following formulae Lm to Ly 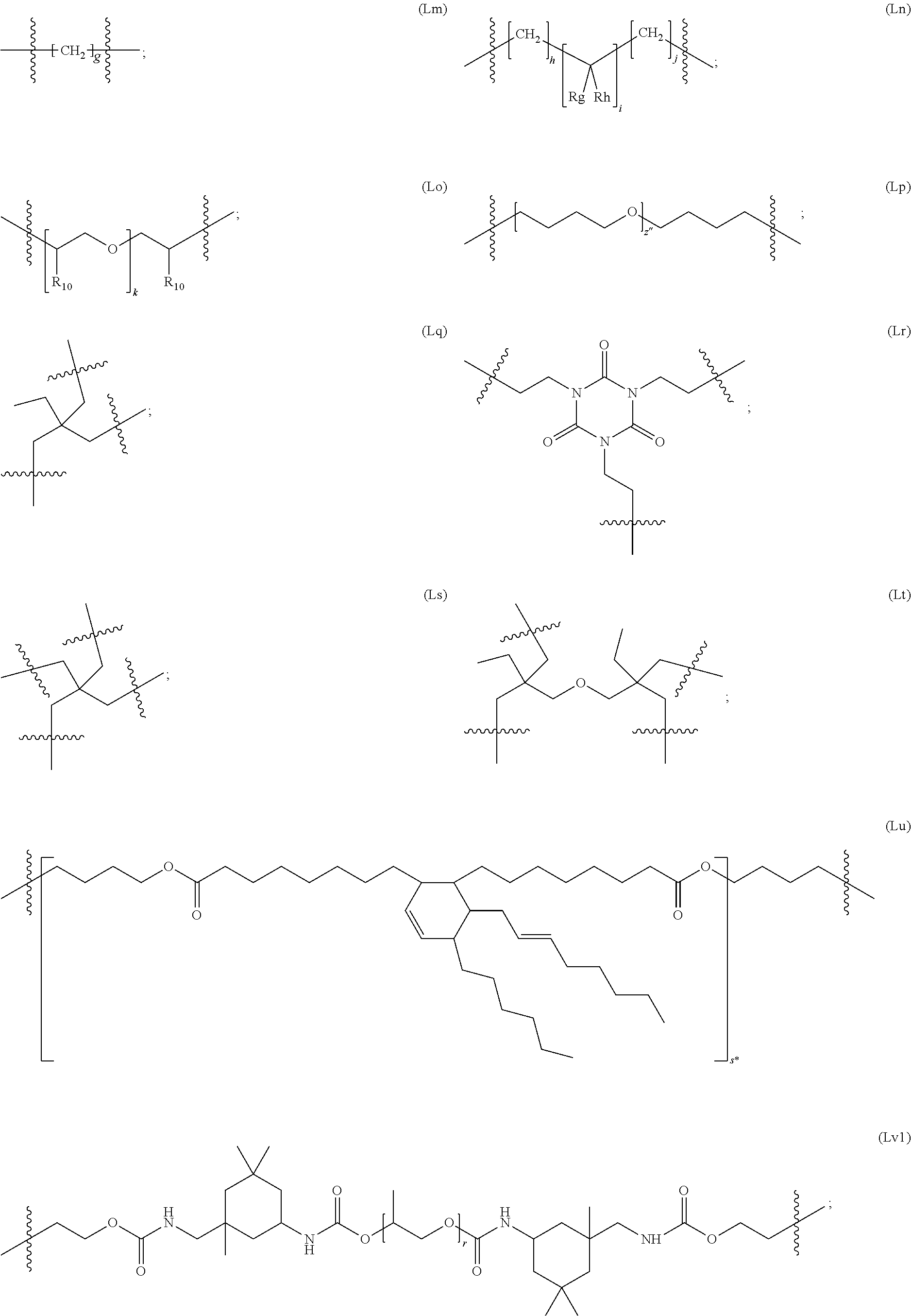 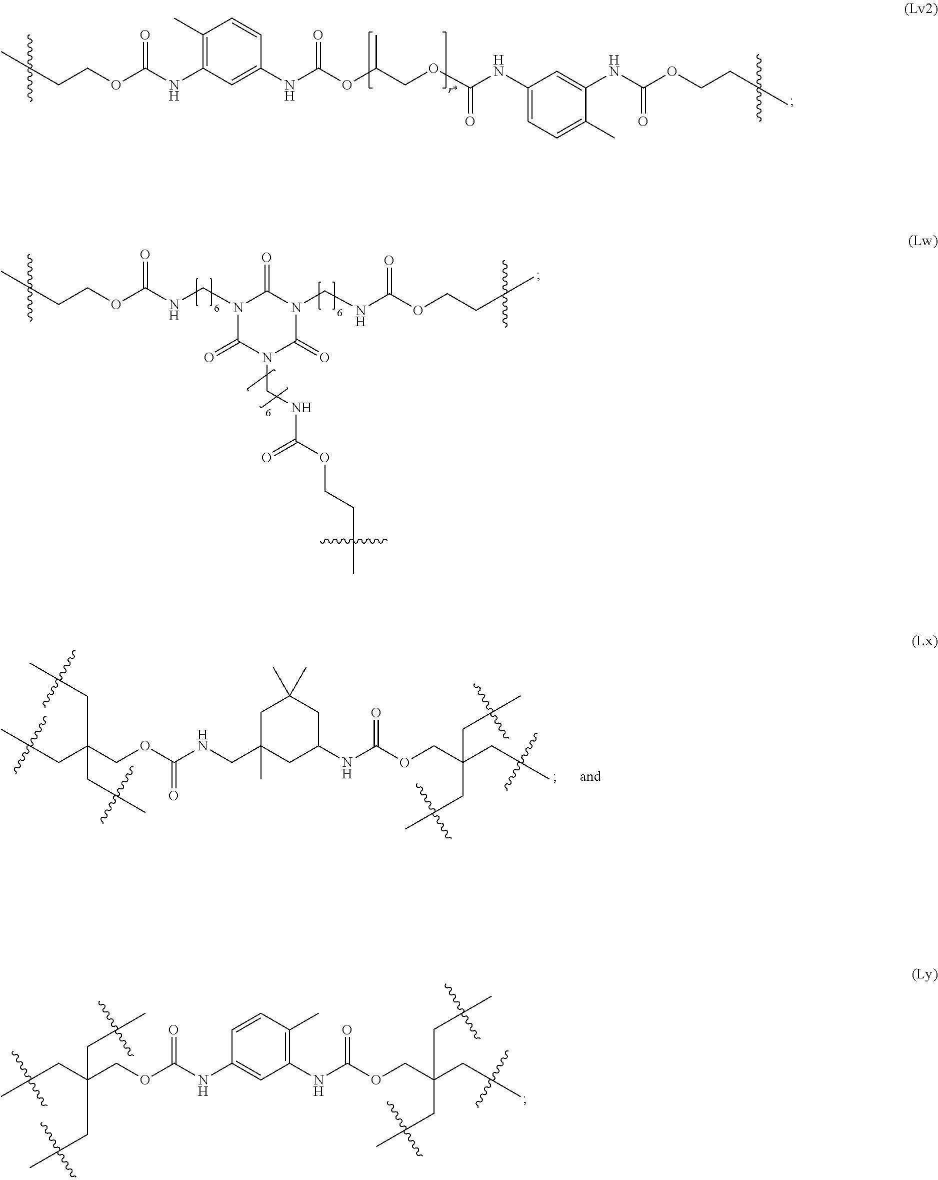
wherein
Q*, w, x and y′ are as defined above;
each R₁₀ is independently H or methyl; preferably methyl
R_{g} and Rₕ are independently H or C1-C20 alkyl, preferably H, methyl or ethyl, more preferably H or methyl;
g is 2 to 20, preferably 3 to 12, more preferably 4 to 10;
h, i and j are independently 0 to 10, preferably 1 to 4, more preferably 1 to 2;
k is 2 to 100; preferably k is between 40 to 80; more preferably between 55 and 75; for example k is 68
r and r* are independently 1 to 70; preferably r is 14 to 70 and preferably r* is 14 to 70;
s* is 1 to 20;
z″ is 5 to 50, preferably 8 to 30, more preferably 10 to 20 or z″ is 5 to 70, preferably 45 to 65, for example z″ is 54
or L is represented by one of the following formulae (Lz) or (Lz′): 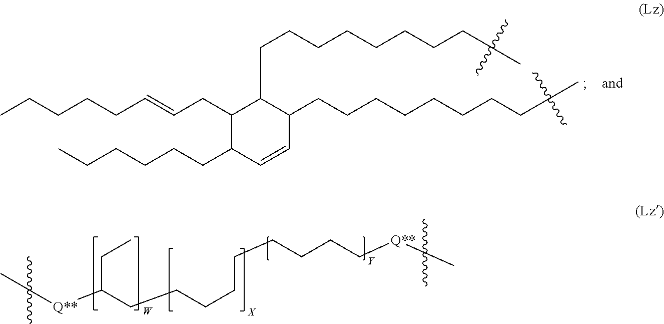
wherein
each Q** is independently a linear or branched alkylene comprising 0 to 100 carbon atoms optionally interrupted by one or more ether and/or ester functional groups,
and (W+X+Y) is between 20 and 70.

2. The prepolymer according to claim 1, wherein the prepolymer is represented by one of the following formulae (1a)-(1c): 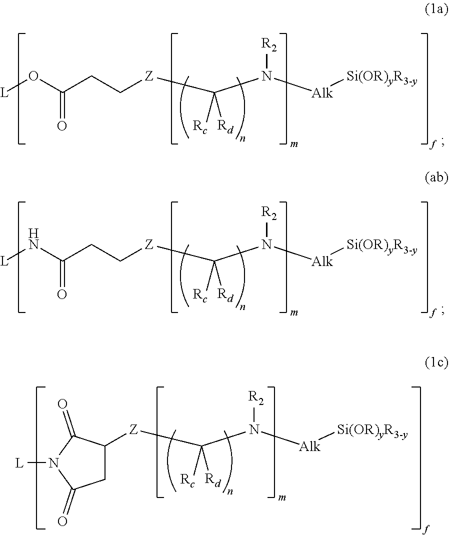
wherein L, Z, R_{c}, R_{d}, R, R₂, Alk, f, m, n and y are as defined in claim 1;
preferably the prepolymer is represented by formula (1a).

3. The prepolymer of claim 1, wherein
Z is S or NR₁, preferably Z is NR₁;
R₁ is H, a C1-C20 alkyl optionally substituted by OH or NRₑR_{f}, a C6-C12 aryl or a C6-C12 alkylaryl; preferably R₁ is H, methyl, ethyl, butyl, cyclohexyl, phenyl or benzyl;
Rₑ and R_{f} are independently H, a C1-C20 alkyl, a C6-C12 aryl or a C6-C12 alkylaryl; and
m is 0.

4. The prepolymer of claim 1, wherein
Z is NR₁;
R₁ and R₂ are independently C1-C20 alkyl, C6-C12 aryl or C6-C12 alkylaryl, preferably methyl, ethyl, phenyl or benzyl, more preferably methyl;
or R₁ and R₂ form a cycle, preferably a piperazine, more preferably an unsubstituted piperazine;
or R₁ forms a cycle with one R_{d} and R₂ forms a cycle with another R_{d} and the remaining R_{d} are hydrogen or C1-C20 alkyl, preferably R₁ forms a piperidine with one R_{d} and R₂ forms a piperidine with another R_{d} and the remaining R_{d} are hydrogen or C1-C20 alkyl;
m is 1.

5. The prepolymer of claim 4, wherein the following group (2): 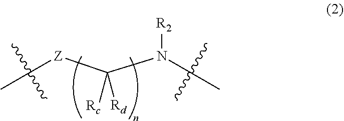
is represented by one of the following formulae (2a)-(2d): 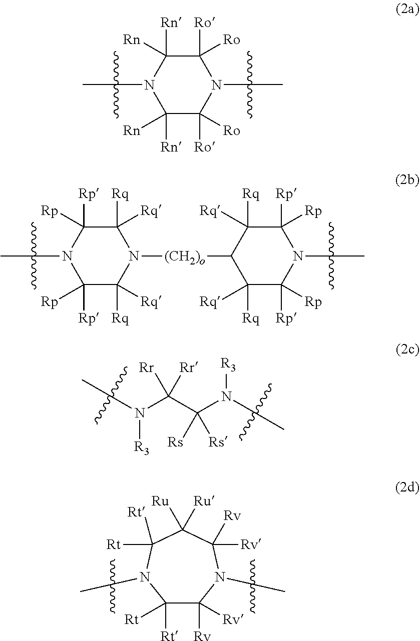
wherein
R₃ is C1-C20 alkyl, C6-C12 aryl or C6-C12 alkylaryl, preferably methyl or ethyl, phenyl or benzyl, more preferably methyl;
each Rₙ, Rₙ′, Rₒ, Rₒ′, Rₚ, Rₚ′, R_{q}, R_{q}′, Rᵣ, Rᵣ′, Rₛ, Rₛ′, Rₜ, Rₜ′, Rᵤ, Rᵤ′, Rᵥ and Rᵥ′ is independently selected from H, C1-C20 alkyl, C6-C12 aryl or C6-C12 alkylaryl, preferably H, methyl, ethyl, phenyl or benzyl, more preferably H or methyl;
o is 0, 1, 2 or 3;
preferably group (2) is represented by formula (2a), more preferably group (2) is represented by formula (2a) and Rₙ, Rₙ′, Rₒ and Rₒ′ are all H.

6. The prepolymer of claim 1, wherein L is represented by the following formula (Lprep) 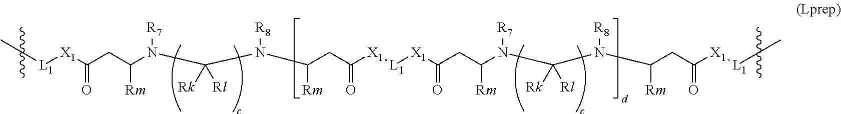
wherein
X₁ is O or NRₙ, preferably X₁ is O;
each L₁ is independently a plurivalent radical, preferably each L₁ has a molecular weight above 500 g·mol⁻¹;
Rₖ is hydrogen;
Rₗ is hydrogen;
or one Rₗ forms a cycle with R₇, another Rₗ forms a cycle with R₈ and the remaining Rₗ are hydrogen, preferably one Rₗ forms a piperidine with R₇, another Rₗ forms a piperidine with R₈ and the remaining Rₗ are hydrogen;
Rₘ is hydrogen;
Rₙ is hydrogen;
or Rₘ forms a cycle with Rₙ, preferably a succinimide;
R₇ and R₈ are independently C1-C20 alkyl, C6-C12 aryl or C6-C12 alkylaryl, preferably methyl, ethyl, phenyl or benzyl, more preferably methyl;
or R₇ and R₈ form a cycle, preferably a piperazine, more preferably a non-substituted piperazine;
or R₇ forms a cycle with one R₁ and R₈ forms a cycle with another R₁, preferably R₇ forms a piperidine with one R₁ and R₈ forms a piperidine with another R₁;
c is 2, 3, 4, 5, 6, 7, 8 or 9;
0<d≤20, preferably 0.5≤d≤10, more preferably 1≤d≤6, even more preferably 1≤d≤4.

7. The prepolymer of claim 1, wherein R is methyl or ethyl and y is 2 or 3, preferably R is methyl and y is 2 or 3.

8. A method for preparing a prepolymer, wherein said method comprises reacting an electrophile of formula (3) or (Prep) with a silane of formula (4): 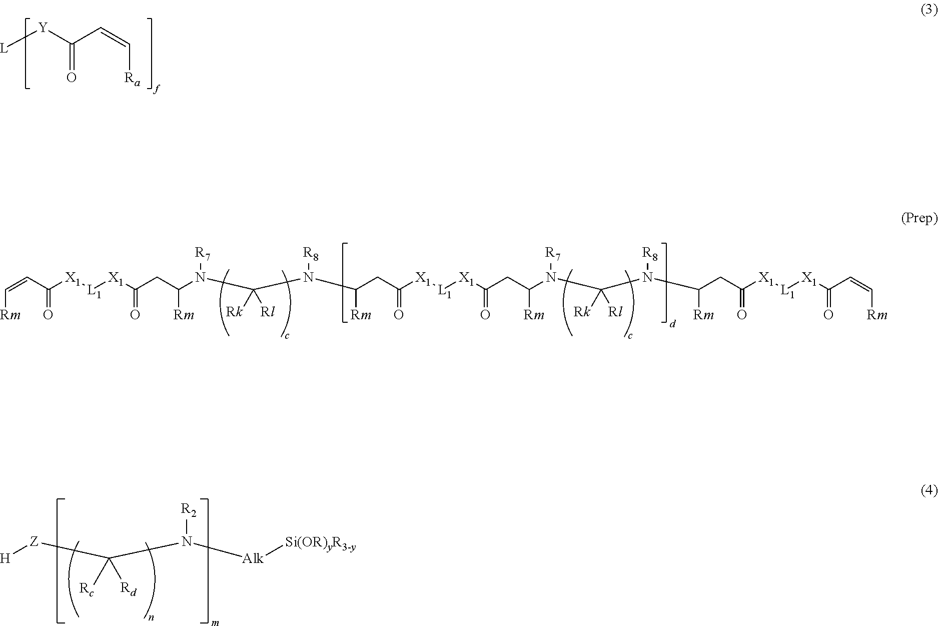
wherein L, Y, Z, R, Rₐ, R_{c}, R_{d}, Alk, f, m, n and y are as defined in claim 1;
L₁, Xₗ, Rₖ, Rₗ, Rₘ, R₇, R₈, c and d are as defined in claim 8;
when Z is S or NR₁ and R₁ is not H, the molar ratio between the hydrogens on the amine or thiol reactive groups of the silane and the α,β-unsaturated carbonyl groups of the electrophile is from 0.8 to 1.2, preferably 0.9 to 1.1, more preferably 0.95 to 1.05;
when Z is NH, the molar ratio between the hydrogens on the amine reactive groups of the silane and the α,β-unsaturated carbonyl groups of the electrophile is from 1.8 to 2.2,
preferably 1.9 to 2.1, more preferably 1.95 to 2.05.

9. Method according to claim 8, wherein the electrophile is represented by one of the following formulae (3a)-(3c) or (PrepA)-(PrepC): 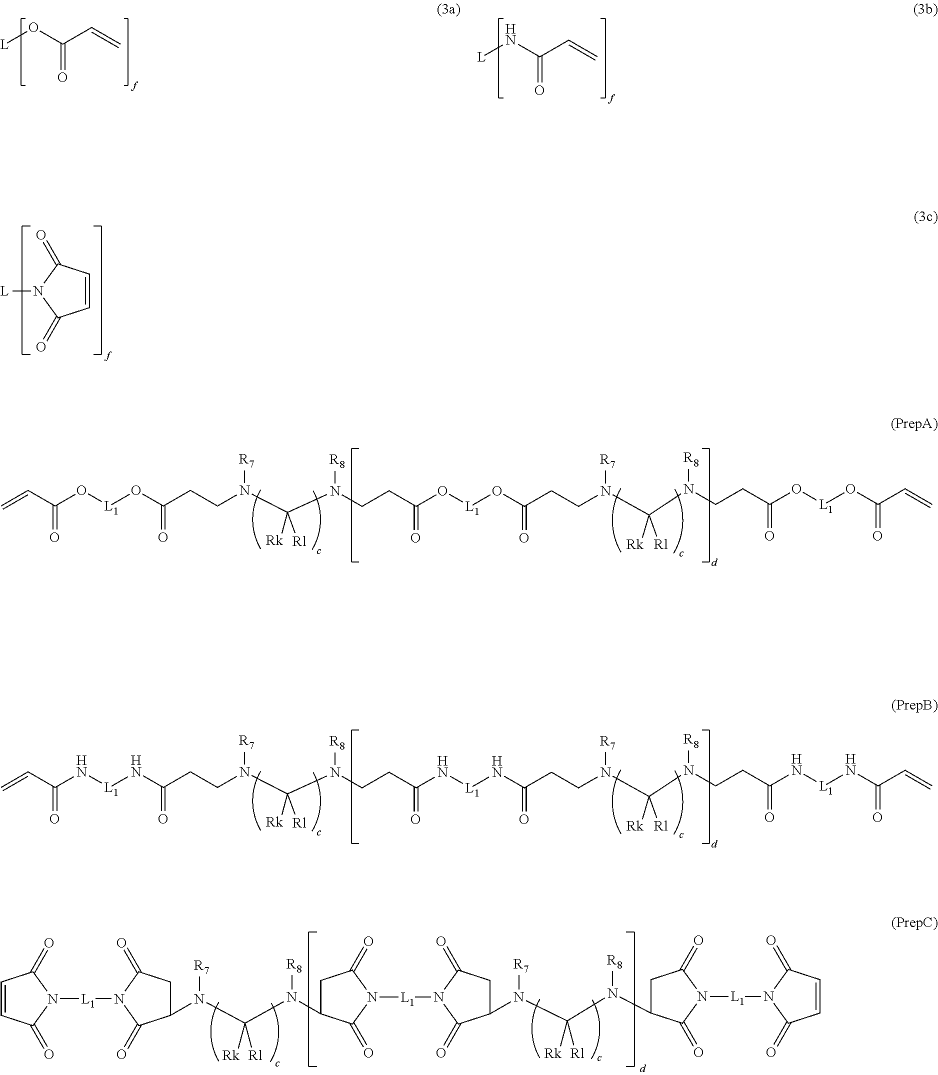
wherein L and f are as defined in claim 1;
L₁, Rₖ, Rₗ, R₇, R₈, c and d are as defined in claim 8;
preferably the electrophile is represented by formula (3a) or (PrepA).

10. The method of claim 8, wherein the silane is represented by one of the following formulae (4a)-(4d): 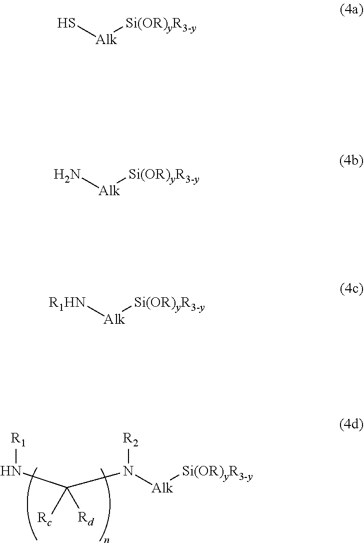
wherein R, R_{c}, R_{d}, R₁, R₂, Alk, n and y are as defined in any one of claims 1-9.

11. A composition comprising:
a prepolymer as defined in claim 1 or as obtained according to the method of claim 8 and mixtures thereof; and
an additive selected from a plasticizer, a filler, an adhesion promoter, a pigment or a dye, an antioxidant a UV-absorber, a UV-stabilizer, a moisture scavenger, a fungicide, a biocide, a fire-retardant, a rheology modifier, an oxygen barrier and mixtures thereof.

12. A sealant, coating or adhesive obtained by curing the composition as defined in claim 11, preferably at a temperature of −10 to 50° C., in particular −5 to 45° C., more particularly 0 to 40° C., during a time of 1 to 72 h, in particular 2 to 30 h, more particularly 3 to 24 h.

13. A method for waterproofing exterior or interior traffic-bearing horizontal surfaces, for making flashings, or for renovating roofs, comprising the step of applying the composition of claim 11.
